(19) United States
(12) Patent Application Publication
(10) Pub. No.: US 2015/0294409 A1
(43) Pub. Date: Oct. 15, 2015

(54) SYSTEMS AND METHODS FOR FACILITATING OFFERINGS OF SECURITIES

(71) Applicant: Morgan Stanley, New York, NY (US)

(72) Inventors: Raghavachari Madhavan, New York, NY (US); Peter Spera, JR., Westport, CT (US); Edward Kim, Brooklyn, NY (US); Zaid Yeganeh, London (GB)

(73) Assignee: Morgan Stanley, New York, NY (US)

(21) Appl. No.: 14/147,130

(22) Filed: Jan. 3, 2014

Related U.S. Application Data
(63) Continuation of application No. 12/387,257, filed on Apr. 30, 2009, now abandoned.
Application No. 12/387,257 is a continuation-in-part of application No. 11/126,893, filed on May 11, 2005, now Pat. No. 8,645,242.

(51) Int. Cl. G06Q 40/04

(52) U.S. Cl. CPC G06Q 40/04

(57) ABSTRACT

Various embodiments are directed to systems and methods for offering a security to potential investors. In various embodiments, a plurality of bids may be received on the security. The bids may be divided by investors into a plurality of investor segments. One of the investor segments may comprise potential investors who are customers of the issuer of the securities. The shares of the offering may be divided into a plurality of tranches where each of the tranches corresponds to one of the investor segments. Shares in a first tranche may be allocated to the corresponding investor segment according to a first allocation method. Shares in a second tranche may be allocated to the corresponding investor segment according to a second allocation method.

### PRIORITY CLAIM

The present application is a continuation-in-part of co-pending U.S. patent application Ser. No. 11/126,893, filed on May 11, 2005, which is incorporated herein by reference in its entirety.

### BACKGROUND OF THE INVENTION

1. Field of the Invention

The present invention generally concerns systems and method for monitoring and conducting auctions and other offerings of securities to potential investors.

2. Background

In an auction offering of financial securities (such as equity or debt securities), the entity handling the auction, typically the underwriter and/or the issuer, must compile and analyze the bids to determine the offering price and the allocations of the securities to the winning bidders. In well-publicized offerings, however, the bidding investors may collectively submit in excess of millions of bids. These bids must be compiled and analyzed in a timely and reliable manner. Such compilation and analysis can present a considerable challenge.

In auction offerings, as well as in traditional book-built offerings, the sheer number of factors affecting the offering can be quite large and may not be accessible from any single source. Accordingly, to gather all of the information relevant to the offering an issuer, underwriter and/or syndicate may have to consult multiple disparate sources, making it difficult to develop a clear picture of the market or the offering process. In addition, when demand is received, the amount of data received from bids/orders can be quite large and not easily presentable. Accordingly, it may be difficult for underwriters, issuers and other offering participants to analyze the bid/order data and make decisions regarding proper offering prices.

### SUMMARY

In one general aspect, the present invention is directed to an auction management system for compiling bids from bidders in an auction of securities. The securities to be auctioned may be equity securities or debt securities. Also, the auction offering may be, for example, an initial public offering, a secondary offering or a follow-on offering. The auction management system may also be used for a buyback in which the issuer offers to buy back shares of securities that it has previously issued. Also, according to various embodiments, especially for buybacks, the auction management system may be located at the issuer of the securities. According to various embodiments, the system includes a data striper and a bid aggregation system. The data striper is for striping bid data compiled from the bids of the potential investors into a plurality of stripes according to an algorithm such that all bids from a particular potential investor (i.e., bidder) are put into a common data stripe. The bid aggregation system is for aggregating the bid data in the stripes.

According to various implementations, the data striper may stripe the bid data according to an identifier for the bidders, such as the investor ID code for the bidders. The investor ID code may correspond to the tax identification number, the social security number, the passport number of the bidder, or a unique, pre-assigned identification code for a party.

The bid aggregation system may perform a first level aggregation on the bid data in the data stripes for combinations of a plurality of attributes related to the bid data. Also the bid aggregation system may perform a second level aggregation based on the first level aggregation. Further levels of integration may also be performed. Striping and aggregating the data in such a manner provides the capability to quickly and robustly analyze the potentially tremendous amount of bid data.

The auction management system may further comprise an analytics system for analyzing the aggregated bid data. The analytics system may receive user requests for analysis of the bid data, perform the analysis in real time based on the user inputs, and serve the results of the analysis to the user. The analysis may be, for example, a trial allocation to winning bidders based on a given supply of securities to be offered, an offering price for the securities, and a specified allocation scheme (e.g., pro rata, max share, etc.). The allocation determinations may be made on the investor level, or even down to the investor-account level. According to various embodiments, the offering may be divided into a number of security tranches and the potential investors may be divided into a number of investor segments. Each investor segment may correspond to one of the tranches. Each tranches may be separately allocated to its associated investor segment. For example, different tranches may be allocated according to different allocation schemes (e.g., pro rata, max share, etc.). The analytics system may also detect potentially manipulative or disruptive bids from the bidders based on, for example, their bidding behavior. Also, the analytics system may permit analysis of the bidder demand for the auctioned securities.

The analytics system may provide real time analysis to multiple concurrent, asynchronous users. In order to do this, according to various embodiments, the system may poll the users to see if an analytical request has been made. If a request has been made, the system will read the user inputs and execute the requested analysis on the relevant bid data. In order to expedite the calculations so that users of the analytics system may obtain results in real time (i.e., within a small response time), the analytics system may employ an indexed memory structure. The indexed memory structure may include, for example, a hierarchically organized system of files containing the bid data for each bid price increment in the range of acceptable bid prices. That is, for example, a file may be created for each bid price increment in the range, and those files may contain the demand profile for the particular bid price by listing the number of bids received at each share lot size. In that way, when a user inputs a particular price (or price range) for trial allocation analysis, the analytics system can quickly retrieve the corresponding price file(s) and do real-time analysis. The results from the analysis may be stored in a database and served to the user via a host server. In other embodiments, the indexed memory structure may include an indexed database structure or memory cache structure.

According to various embodiments, a user interface may be provided. The user interface may be used in an auction offering or a traditional book-building offering and may present various offering-related data to users (e.g., representatives of the issuer, underwriter, etc.). The user interface, for example, may comprise a market window showing data describing a market price of a plurality of related companies. The related companies may be selected from a plurality of publicly traded companies or other companies where data is publicly available. The interface may also comprise a news window that may provide links to news, video, blogs, research, and/or text communications. The content shown may be selected, for example, based on its relevance to the related companies.

Also, according to various embodiments, a demand and/or allocation user interface may be shown to the users. The demand and/or allocation interface may provide a demand field showing demand data (e.g., bids for auctions, offers to purchase for other offerings, etc.) as a function of other variables (e.g., a demand break down by investor type, geographic area, etc.). An offering price field may be for receiving from the user an indication of an offering price. The demand field may be modified to show the demand data given the offering prices entered at the offering price field. In various embodiments, the offering price field may comprise a slide bar for setting the offering price.

These and other benefits of the invention will be apparent from the description to follow.

### DESCRIPTION OF THE FIGURES

Various embodiments of the present invention are described herein by way of example in conjunction with the following figures, wherein:

FIG. 1 is a diagram of an auction management system according to various embodiments of the present invention;

FIG. 2 is a diagram of a data transfer system according to various embodiments of the present invention;

FIG. 2A is a diagram of a process for rounding off fractional share allocations according to various embodiments of the present invention;

FIG. 3 is a diagram illustrating the data striping process performed by a data striper according to various embodiments of the present invention;

FIG. 4 is a diagram illustrating the aggregations performed by a bid aggregation system according to various embodiments of the present invention;

FIG. 4A is a diagram of a process for distributing under-allocated shares in a multiple investor segment auction according to various embodiments of the present invention;

FIG. 4B is a diagram of a process for rebalancing over-allocated shares in a multiple investor segment auction according to various embodiments of the present invention;

FIG. 5 is a diagram of an analytics system according to various embodiments of the present invention;

FIGS. 6 and 7 are exemplary charts generated by the analytics system according to various embodiments of the present invention;

FIG. 8 is a diagram of the process flow through a max share calculation module according to various embodiments of the present invention; and

FIGS. 9-17 depict user interfaces generated by the auction management system for analysis of the aggregated bid data according to various embodiments of the present invention.

FIG. 18 is a diagram of the analytics system of FIG. 5 according to various embodiments of the present invention.

FIG. 19 depicts a user interface generated, according to various embodiments of the present invention, to provide aggregated data to various users.

FIG. 20 depicts one embodiment of the user interface of FIG. 19 configured to show details of a calendar item selected from the Auction Calendar field.

FIG. 21 depicts one embodiment of the user interface of FIG. 19 configured to show a Market Data breakout field.

FIG. 22 depicts one embodiment of the user interface of FIG. 19 displaying a Demand screen.

FIG. 23 depicts one embodiment of a series of windows from the Demand screen of FIG. 22.

FIG. 24 depicts one embodiment of a second series of windows from the Demand screen of FIG. 22.

FIG. 25 depicts one embodiment of the user interface of FIG. 19 displaying an Allocations screen.

FIG. 26 depicts one embodiment of the Allocations screen of FIG. 25 illustrating an allocation stage.

FIG. 27 depicts one embodiment of the Allocations screen as shown in FIG. 25 with the Demand and Allocation Decisions windows expanded.

FIG. 28 depicts one embodiment of the Allocations screen as shown in FIG. 25 displaying an allocation result stage.

### DESCRIPTION OF THE INVENTION

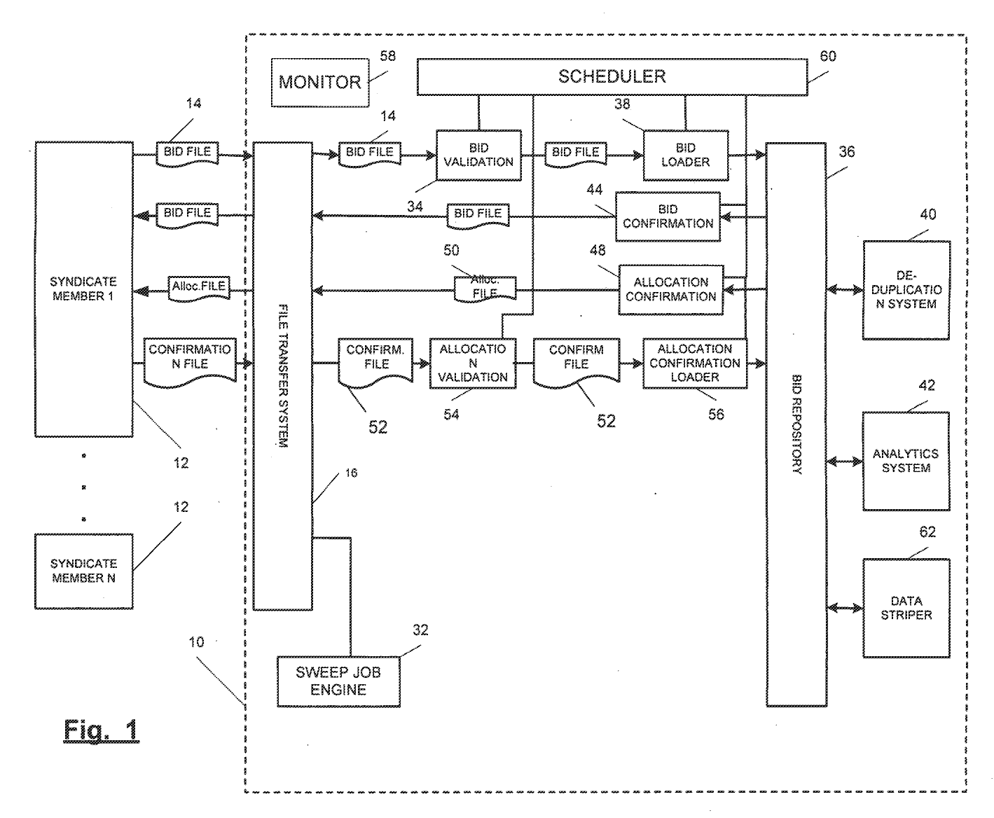

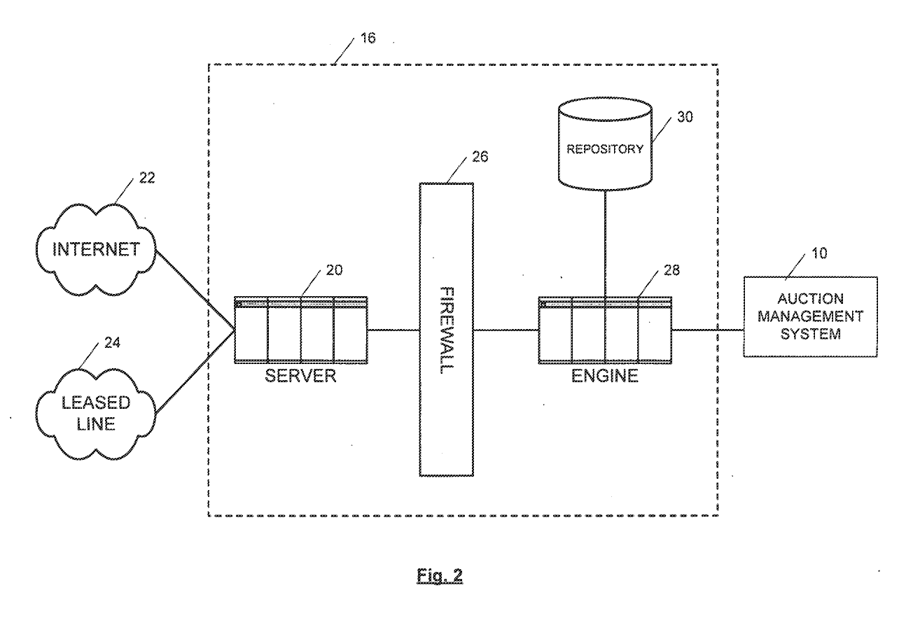

FIG. 1 is a diagram of an auction management system 10 according to various embodiments of the present invention. The auction management system 10 may be used to manage an auction of securities issued by an issuing company (the “issuer”). The securities may be equity securities, such as common stock, debt securities, such as bonds or notes, or convertible instruments. For example, for an equities offering, the securities may be common stock issued by the issuer as part of an IPO, a secondary offering or a follow-on offering, and prospective bidders may input bids comprising a share price and a share quantity. For a debt offering, the bids may comprise a yield (e.g., an absolute rate, a spread above a benchmark rate of return, a coupon rate, etc.) and an indication of quantity (e.g., a dollar amount corresponding to a quantity of the debt securities to be purchased at par value). The description to follow assumes that the offered securities are equity securities, although it should be recognized that the description is applicable to debt security offerings. Also, although the term “share” is used herein to refer to a single unit of the securities, it will be appreciated that the systems and methods described herein are equally applicable to non-equity securities having units other than “shares” (e.g., a minimum notional value of a bond offering, etc.). The offering may also be a buyback in which the issuer offers to buy back shares of securities that it has previously issued. In this case, the auction participants are holders of the issued securities, and the bids still include a price (or yield) and quantity. Also, it will be appreciated that securities offerings are subject to applicable law and regulations. Accordingly, the system 10 may always be configured to comply with applicable law and regulations.

The auction management system 10, as well as the various systems and sub-systems included therewith, may be implemented utilizing one or more computer devices. Each computer device may comprise one or more electronic processors (e.g., processor circuits) in communication with an electronic memory circuit (e.g., volatile or non-volatile memory). The memory may store instructions that, when executed by the processor or processors, cause the processor or processors to perform the tasks described herein.

In the auction management system 10 of FIG. 1, potential investors (not shown) may communicate bids to syndicate members 12 participating in the auction process. The syndicate members 12 may be, for example, broker/dealers. The syndicate may include one or more underwriters that assist the issuing company in the offering process. In various embodiments, investors may submit more than one bid, each such bid having a different combination of price and quantity. Also, bidding investors may submit bids to different syndicate members. As shown in FIG. 1, there may be N syndicate members.

When a syndicate member 12 is ready to submit bids received from bidding investors to the auction management system 10, the syndicate members 12 may prepare and submit bid data 14 to a computer-implemented file transfer system 16 of the auction management system 10. The bid data 14 may conform to a predetermined file format and may include identifiers for the following information: an auction ID to identify the relevant auction, a code for the syndicate member, an investor ID, an account ID for the investor (e.g., an account number indicating the investor's account at the syndicate member), a country code for the investor, a code for the type of investor (e.g., individual or institutional), a code for the order type (e.g., institutional or retail order), a code for whether the bidding investor participated in the road show by the issuer, the bid amount (e.g., the quantity of securities requested), the bid price and a time stamp for the time the bid was received. The file transfer system 16 may be any suitable means for facilitating the receipt of the bid data 14 including, for example, a World Wide Web or other interface, a mainframe link, etc. The auction management system 10 may add data to various fields of the bid data 14 as the bids are validated or otherwise processed, as described in more detail below.

The investor ID may be, for example, the investor's tax identification number (TID), the investor's social security number, the investor's passport number, or a unique, pre-assigned alphanumeric identification code for the investor. The investor ID may also include the country-code of the issuing country (i.e., the country issuing the TID, social security number or passport number). As mentioned before, an investor may submit more than one bid. If an investor submits more than one bid with a single syndicate member 12, the bid data 14 may list each bid. If the investor submits different bids to different syndicate members, the bid files from the separate syndicate members may respectively list the separate bids from the investor.

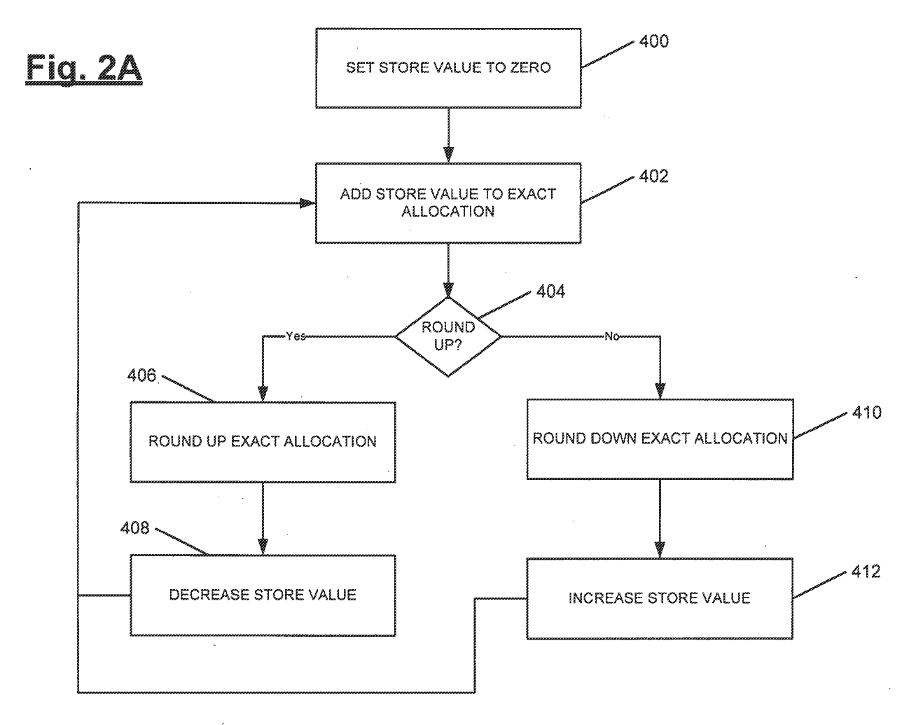

The bid files 14 submitted to the auction management system 10 by the syndicate members 12 are preferably encrypted (such as with PGP or GPG encryption techniques) and compressed. The bid files 14 may be exchanged with the file transfer system 16 using, for example, the File Transfer Protocol (FTP). The file transfer system 16 preferably is a secure, automated computer-implemented file transfer system 16 that allows the syndicate members 12 to easily exchange information with the auction management system 10. FIG. 2 is a diagram of the file transfer system 16 according to various embodiments of the present invention. A computer-implemented server 20 of the file transfer system 16 may receive the bid files from the syndicate members via data communication links, such as either the Internet 22 or a leased data communication line 24, for example. A firewall 26 may prevent unauthorized access to the auction management system 10. A computer-implemented file transfer engine 28 may store the uploaded files in a repository 30 and transmit the uploaded bid files from the repository 30 to the remainder of the auction management system 10 as needed. The engine 28 may also decrypt and uncompress incoming files, and encrypt and compress outgoing files.

When the bid files 14 have been successfully uploaded to the file transfer system 16, the file transfer system 16 may create a marker file (not shown) indicating completion of the file transfer. The marker file may be written to the repository 30. A computer-implemented sweep job engine 32 (see FIG. 1) may run through the file transfer system repositories 30 looking for the marker file. When found by the sweep job engine 32, the corresponding bid files 14 may be transmitted to a bid validation module 34. The computer-implemented bid validation module 34 may individually validate bid data 14 submitted by the syndicate members 12. The bid validation module 34 may validate the bid files 14 by determining whether all of the data in the bid files are valid. For example, the bid validation module 34 may check to ensure that the bid price and/or quantity are not negative numbers, whether the auction and syndicate IDs are valid, whether the country code is valid, etc. If the bid is valid, the bid validation module 34 may update a bid status code of the bid data 14 to indicate that the bid is valid. The updated bid data 14 may then be uploaded into a bid repository 36 by a bid loader 38. The bid repository 36 may be, for example, a Sybase repository. In other embodiments, the bids from the investors may be submitted in real time.

As illustrated in FIG. 1, the auction management system 10 may also include a computer-implemented de-duplication system 40 and a computer-implemented analytics system 42. The de-duplication system 40 may determine whether an investor has submitted duplicative bids. If so, according to one embodiment, all or all but one of the duplicative bids may be determined to be invalid. According to other variations, all bids from the investor submitting duplicative bids (including non-duplicative bids) may be determined to be invalid. The analytics system 42 performs analysis on the bid data based on user requests. More details regarding the de-duplication system 40 and analytics system 42 are provided below.

A computer-implemented bid confirmation module 44 may update the bid data 14, such as by updating fields in the file to indicate that the bids are valid and/or confirmed. The updated bid data 14 may then be transmitted to the syndicate members 12 via the file transfer system 16. The sweeps by the sweep job engine 32 may be performed periodically. For example, for an auction lasting several days, the sweep job engine 32 may run daily, twice a day, or at some other interval. Updated bid data for analysis by the analytics system 42 is available following each sweep (or “sweep job”).

Once the time period set for submitting bids has closed, shares of the issued securities can be allocated to the winning bidders. The clearing price for the auction may correspond to the lowest successful bid price. The offering price may correspond to the clearing price, or it may be different from the clearing price (for example, slightly less than the clearing price). All bidders submitting a bid price at or above the offering price may be allocated one or more shares. The shares may be allocated to the winners on, for example, a pro rata basis or on a “max share” basis. For pro rata allocations, a pro rata allocation percentage may be determined by dividing the total number of shares offered by the number of shares represented by valid successful bids. Each bidder who has a successful bid is allocated a number of shares approximately equal to the pro rata allocation percentage multiplied by the number of shares represented by the successful bid (subject to rounding of fractional shares).

In a max share allocation, all successful bidders who requested a number of shares equal to or in excess of the max share amount receive approximately the max share amount (subject to rounding of fractional shares), and successful bidders who requested less than the max share amount receive their requested amount.

Without rounding, the allocation process is likely to result in fractional shares being awarded to at least some investors. If all of the fractional shares are automatically rounded down, not all of the shares to be issued will be allocated. On the other hand, if all of the fractional shares are rounded up, the cumulative allocation to the investors will exceed the number of securities offered in the offering. To address this dilemma, a rounding algorithm may be used to ensure that each successful bidder is allocated an integral number of shares and that the total number of shares offered is allocated. Provided below is one way of solving this non-trivial problem.

FIG. 2A is a diagram of a rounding algorithm using a store approach that may be used according to various embodiments, and Table 1 below provides a simplified, hypothetical example of how the process may work using a pro rata allocation. In this example, 10,000 shares are offered, and the total number of shares demanded by the successful bids is 15,025. In that case, the pro rata allocation percentage is 66.5557404%. The allocation that the successful bidders would receive based on the pro rata allocation percentage, without rounding, is shown in column 3 of the table as the “Exact Allocation,” computed by multiplying the pro rata allocation percentage by the number of shares demanded by the successful bidder (column 2).

TABLE 1

| | | | | Actual | Store After |
|---|---|---|---|---|---|
| Bidder | Shares Demanded | Exact Allocation | Store | Allocation | Allocation |
| A | 1,005 | 668.88519130 | 0 | 668 | 0.885191348 |
| B | 2,005 | 1,334.44259600 | 0.885191348 | 1,335 | 0.327787022 |
| C | 3,005 | 2,000.00000000 | 0.327787022 | 2,000 | 0.327787022 |
| D | 4,005 | 2,665.55740400 | 0.327787022 | 2,665 | 0.88519134 |
| E | 5,005 | 3,331.11480900 | 0.855191348 | 3,332 | 0 |
| Total | 15,025 | 10,000.00000000 | | 10,000 | |

Using the store approach, at step 400, the initial store value is set to zero. For the first successful bidder, at step 402, the store value is added to the “Exact Allocation” for the first bidder. Then, at step 404, whether the allocation to the first investor can be rounded up is determined based on the formula int|Store+Exact Allocation|≧int|Exact Allocation|+1. If this statement is true, then at step 406, the actual allocation to the investor is rounded up to the next integer (i.e., Actual Allocation=int|Exact Allocation|+1) and, at step 408, the store value is decreased by the appropriate amount (i.e., Store=Exact Allocation+Store−Actual Allocation). On the other hand, if at step 404 it is determined that the allocation to the investor should not be rounded up (i.e., int|Store+Exact Allocation|<int|Exact Allocaiton|+1), then, at step 410, the allocation to the investor is rounded down (i.e., Actual Allocation=int|Exact Allocation|) , and, at step 412, the store value is increased by the fractional portion of the exact allocation (i.e., Store=Store+Exact Allocation−int|Exact Allocation|). This process is repeated for each successful bidder, with the successful bidders being processed, for example, in a sorted order based on their investor ID number.

With reference to the example of Table 1, since the store value is zero for investor A, the actual allocation for investor A is rounded down to 668, and the store value is increased to the fractional value of the exact allocation to investor A, i.e., 0.88519348. The allocation to investor B is then rounded up to 1,335 because the sum of the revised store value (i.e., 0.88519348) and the exact allocation for investor B (i.e., 1,334.44259600) exceeds 1,335. In that case, the store value is revised down to 0.327787022. The process is repeated for each winning bidder. According to an alternative rounding algorithm, all fractional share allocations may be rounded down. The remaining shares may be allocated according to an alternative allocation method (e.g., a lottery among the winning bidders).

With a max share allocation, successful bidders with bid sizes less than or equal to a maximum share amount receive share allocations for their entire bid amounts (subject to the rounding algorithm) and successful bidders with bid sizes greater than the maximum share amount receive the maximum share amount (subject to the rounding algorithm). That is, each successful bidder receives a share allocation approximately equal to the lesser of the number of shares represented by their successful bid and the maximum share amount. The maximum share amount is selected as the number of shares that result in the full allocation of the shares being offered. For example, assume 20,000 shares are offered, and the total number of shares subject to successful bids is 21,200. In this simplified, hypothetical example, as shown in Table 2, the maximum share allocation is 4,650 and the shares are allocated to the successful bidders as follows:

TABLE 2

| Successful | Shares Requested | |
|---|---|---|
| Bidder | by Successful Bid | Share Allocation |
| A | 100 | 100 |
| B | 2,100 | 2,100 |
| C | 4,000 | 4,000 |
| D | 4,500 | 4,500 |
| E | 5,000 | 4,650 |
| F | 5,500 | 4,650 |
| Total: | 21,200 | 20,000 |

In the example of Table 2, a rounding algorithm was not needed to ensure that all of the offered shares were allocated. In practical applications of the max share allocation technique where the exact allocation to one or more successful investors includes fractional shares, a rounding algorithm such as the above-described store-approach rounding algorithm may be used.

According to various embodiments, and as allowed by applicable law, the securities to be auctioned may be divided into multiple tranches (e.g., by the auction management system 10). Each tranche may be separately allocated to a pre-selected segment of potential investors. Any suitable allocation method may be used to allocate the tranches to their associated investor segments. In some embodiments, the same allocation method may be used across all tranches, while, in other embodiments, different tranches may be allocated to their associated investor segments according to different allocation methods (e.g., pro rata, max shares, lottery, etc.). The selection and population of investor segments, as well as the allocation may be performed by and/or facilitated through any suitable computer equipment included in the auction management system 10 including, for example, the allocation module 134 of the analytics system 42.

The potential investors may be divided into segments according to any suitable method. For example, the potential investors may be divided into a first tranche including institutional investors and a second tranche including retail investors. In various embodiments, the investor segments may reflect smaller groups of potential investors, subject to applicable regulation. For example, different classes of retail and institutional investors may be assigned to different segments. Although retail and institutional investor segments are used in many of the examples provided herein, it will be appreciated that investor segments may be formed according to any suitable categorization.

The system 10 may distinguish between investors based on the investor ID code received with each bid. According to various embodiments, the system 10 may verify identity of an investor with information received from the issuer. For example, if an investor reports that they are a member of a given class of customers of the issuer, the system 10 may receive from the issuer a list of the customers in the given class and cross-reference the list with the reporting investor. In some embodiments, the system 10 may prevent investors from being in more than one segment. If an investor otherwise would appear in more than one segment, then the system 10, in accordance with applicable law, may place the investor in the most favorably treated segment for which the investor qualifies. The most favorably-treated segment may be based on disclosure data regarding the offer and may be determined based on any suitable criteria. For example, a most-favorably treated segment may be the segment with the highest number of allocated shares relative to potential demand.

In some embodiments, at least one of the segments may be comprised of investors having a predefined affinity to the issuer, the underwriters and/or the various syndicate members 12. The affinity may represent a relationship between the potential investor and the issuer, underwriters and/or syndicate members 12 that may make it advantageous to the issuer for the potential investor to own the security. For example, the issuer may want to reserve affinity-based tranches for potential investors who are customers of the issuer (e.g., to reward those customers). Also, for example, the issuer may want to reserve affinity-based tranches for potential investors who have investing habits that are advantageous to the issuer (e.g., investors who tend to buy and hold, investors who are in a geographic or market segment in which the underwriter and/or various syndicate members 12 have a high degree of market penetration, etc.). In various embodiments one or more investor segments may be reserved for investors who took part in a road show or one-to-one with the underwriters and/or officers or representatives of the issuer. In one example, an issuer who is a retailer may define a customer affinity segment comprising potential investors who are customers of the retailer as above a predetermined threshold (e.g. customers who have charged greater than a predetermined amount on-their retailer-issued charge card in a predetermined period). Other affinity-based investor segments may be determined based on customer or other parties that refer a predetermined number of customers or volume of business to the issuer, customers who are profitable to the issuer above a predetermined threshold, and customers who patronize the issuer above a predetermined frequency. Affinity segments may also be defined at any given level of granularity. Returning to the retailer example, customers may be assigned to different affinity segments based on the amount of their purchases. Also, for example, in embodiments where the issuer is an airline, customers may be assigned to different affinity segments based on their frequent flier status (e.g., gold, silver, etc.). According to various embodiments, the system 10 may maintain a table or other data structure associating each individual investor ID code with a set of attributes describing the associated investor. Investors may then be organized into investor segments based on an evaluation of their attributes.

Table 2.1 below illustrates an offering broken into multiple tranches corresponding to affinity segments. In the example shown in table 2.1, the issuer is an airline and multiple segments and associated tranches are assigned to different levels of frequent fliers:

TABLE 2.1

| Potential Investor | Tranche Size | Tranche Size |
|---|---|---|
| Segment | (Numerical) | (% Of Offering) |
| Institutional | 6M | 60% |
| Investors | | |
| Retail Investors | 2M | 20% |
| (Other) | | |
| “Platinum” | 1M | 10% |
| Frequent Fliers | | |
| “Gold” | 750k | 7.5% |
| Frequent Fliers | | |
| “Silver” | 250k | 2.5% |
| Frequent Fliers | | |
| Total: | 10M | 100% |

As shown, the size of a given tranche may be indicated by a number of shares or by a percentage of the total offering. The shares in any given tranche may be allocated to their associated investor segment according to any suitable method. For example, all of the tranches shown in Table 2.1 may be assigned to their associated investor segments according to a max shares method, as described above. Also, in various embodiments, 6 million shares in the Institutional Investor tranche may be allocated to the institutional investors according to a max shares method, while the 250 thousand shares of the “Silver” Frequent Fliers tranche may be allocated according to a pro rata and/or lottery method.

According to various embodiments, investor segments may be arranged hierarchically. Using the example above, the “Platinum,” “Gold,” and “Silver” frequent fliers may be arranged hierarchically under a “Frequent Fliers” investor segment. It will be appreciated that hierarchies of any complexity and depth may be used, of course, subject to applicable law. When a hierarchy is used, allocations to parent investor segments may affect the allocations to their child investor segments. The tranches associated with child investor segments may be subsets of the tranche associated with parent investor segments. For example, if 1M shares are allocated to a parent investor segment, then the sum of the allocations to investors in the child investor segments should equal 1M shares. It will be appreciated, however, that parent and child investor segments need not use the same allocation method. Also, it will be appreciated that, in some embodiments, there may be investors who fall within a parent investor segment, but not within any of its child investor segments. In this case, a new child investor segment may be generated to include investors who fit the parent investor segment but do not fit within any of the child investor segments. Also, in some embodiments, these investors may be allocated shares that are left over after the child investor segments are allocated. In various embodiments, not all portions of the hierarchy will reach the same level of granularity. For example, some segments may be allocated at a high level, while others may be broken into multiple, smaller segments which may each be allocated separately.

When there are multiple tranches and segments, as described above, allocating 100%, and only 100% of the offering among the investor segments may be challenging. Accordingly, the system 10 may provide functionality for correcting under and over allotment conditions. In an under-allotment condition, less than all of the shares of the offering may be allocated to the various tranches. In an over-allotment condition, more than all of the shares of the offering may be allocated to the various tranches.

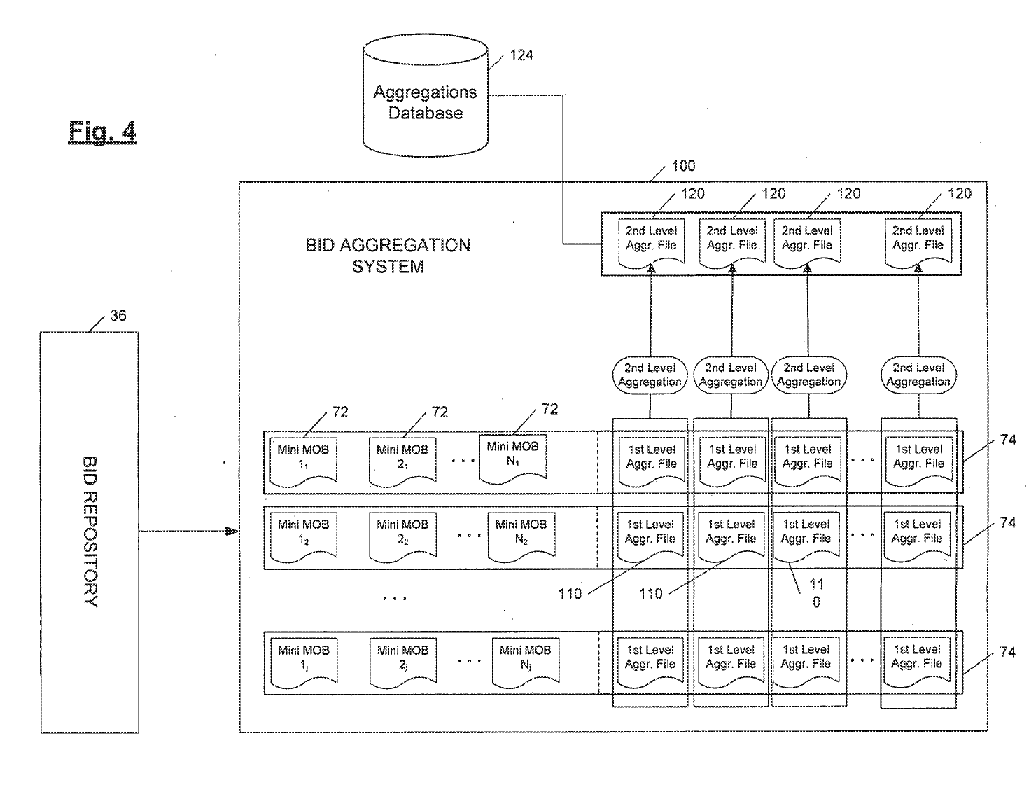

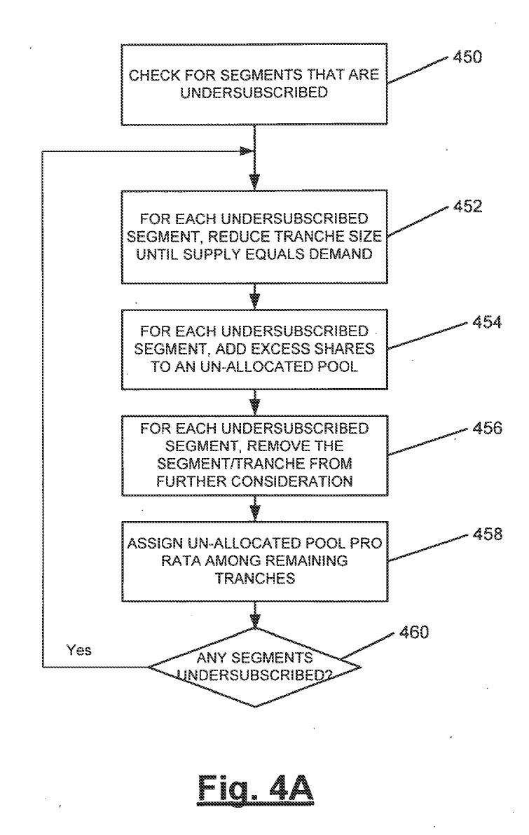

FIG. 4A is a diagram of a process for correcting an under-allotment condition in a multiple investor segment auction according to various embodiments of the present invention. The process of FIG. 4A may be implemented by any suitable computer equipment included in the auction management system 10. For example, the process of FIG. 4A may be implemented by the allocation module 134 of the analytics system 42.

First, investor segments that are undersubscribed may be identified at step 450. An investor segment that is undersubscribed may be one with demand that is less than the number of shares in its associated tranche. For each investor segment that is undersubscribed, the number of shares in the associated tranche may be reduced at step 452 until the supply and demand are equal. The shares removed from each undersubscribed segment may be added to an un-allocated share pool at step 454. The now balanced segment/tranche combination may then be removed from further consideration at step 456. At step 458, the un-allocated pool may be assigned pro rata across the remaining tranches. If at step 460 it is determined that any of the remaining segments have become over-allocated, then the process may return to step 452 described above. This may be repeated until no undersubscribed segments remain. It will be appreciated that this optional process may more efficiently allocate shares across investor segments in an under-allocation condition.

FIG. 4B is a diagram of a process for correcting an over-allotment condition in a multiple investor segment auction according to various embodiments of the present invention. Like the process of FIG. 4A, the process of FIG. 4B may be implemented by any suitable computer equipment included in the auction management system 10. For example, the process of FIG. 4B may be implemented by the allocation module 134 of the analytics system 42.

At step 462, excess shares are subtracted from the tranches corresponding to any investor segments that are undersubscribed. Because an over-allotment condition means that more shares than the available number of shares have been allocated to the various tranches, removing excess shares from any undersubscribed investor segments may reduce the quantity of the over-allotment. The sum of the remaining number of over-allocated shares may be subtracted from all tranches pro rata at step 464. If this results in less than 0% allocation for any investor segment, then its corresponding tranche is reduced to 0% allocation at step 468 and any excess over-allocated shares are added to an over-allocated shares pool at step 470. Any segment/tranche combination at 0% allocation may be removed from further consideration at step 472. If, at step 474, the over-allocated shares pool is not equal to zero, the process may repeat from step 464 until the number of over-allocated shares is equal to zero.

Once the allocations are complete and finalized, using the pro rata, max share or any other allocation approach, an allocation confirmation module 48 may prepare an allocation file 50 for publication to the syndicate members 12 by the file transfer system 16. The syndicate members 12 may then confirm the allocations by submitting a confirmation file 52. The confirmation file 52 is validated by an allocation validation module 54 and loaded in the bid repository 36 by an allocation confirmation loader 56.

According to various embodiments, the process of validating bids, confirming bids, confirming allocation and validating allocations may be monitored by, for example, a web-based monitoring system 58. In addition, a scheduler 60 may schedule the process flow.

The bid validation module 34, the bid loader 38, the bid confirmation module 44, the allocation confirmation module 48, the allocation validation module 54 and the allocation loader 56 may be implemented as software code to be executed by processors (not shown) of the auction management system 10. The software code may use any suitable computer language, such as, for example, Java, C, C++, Sybase SQL, or Perl, etc., using, for example, conventional or object-oriented techniques. The software code may be stored as a series of instructions or commands on a computer-readable medium, such as a random access memory (RAM), a read-only memory (ROM), a magnetic medium such as a hard drive or a floppy disk, or an optical medium, such as a CD-ROM.

Also, to increase system robustness, the auction management system 10 may utilize parallel processing techniques. For example, each syndicate member 14 may have an associated bid validation module 34, bid loader 38, bid confirmation module 44, allocation validation module 54 and allocation loader 56. That way, separate validation and confirmation systems can be dedicated to each syndicate member. Accordingly, the system 10 may include, for example, a validation system including a number of validation modules 34 operating in parallel to validate bid files 14 from the various syndicate members 12. For the sake of clarity, only the modules associated with one syndicate member are shown in FIG. 1, although it should be recognized that, according to various embodiments, there might be corresponding modules for each of the N syndicate members.

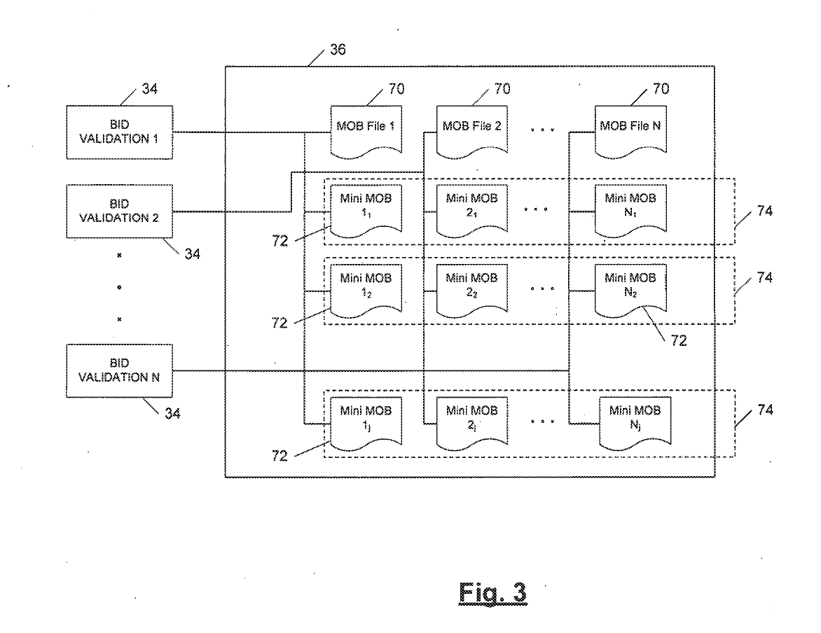

In order to more robustly analyze the bids, a data striper 62 may segment the data in the bid files 14 loaded into the bid repository 36 according to a data striping technique. Data striping involves the segmentation of logically sequential data into a number of segments or files. For example, according to various embodiments, as shown in FIG. 3, the bid repository 36 may include a master order book file (MOB) file 70 for each syndicate member 12. Thus, if there were N syndicate members, there would be N MOB files 70. In addition, the data striper 62 may segment the bid data for each syndicate member into a number of mini-MOB files 72. For example, the bid data for each syndicate member may be segmented into j mini-MOB files 72. In that case, there would be N×j such mini-MOB files 72. Flat files, databases or any other data storage and organization mechanism may be used for storage of the mini-MOB files.

The mini-MOB files 72 for each syndicate member may be segmented using an algorithm in a way that facilitates parallel aggregation of the data. Preferably, an algorithm that segments the bid data into more manageable pieces and that puts all bids from a particular bidder in the same data stripe is used. In that way, the number of unique bidders can be more easily and readily determined. According to one embodiment, for example, the algorithm may be based on the investor ID code. For example, the algorithm may segment the bid data based on a truncation the investor ID (e.g., the last one or more digits of the investor ID code). Recall that the investor ID code may correspond to the investor's TID, social security number, passport number, or a unique identification code. Thus, for such one embodiment, all bids from syndicate member 1 whose investor ID ends in 1 may be written to mini-MOB file 1₁, all bids from syndicate member 1 whose investor ID ends in 2 may be written to mini-MOB file 1₂, and so on. In addition, all bids from syndicate member 2 whose investor ID ends in 1 may be written to mini-MOB file 2₁, all bids from syndicate member 1 whose investor ID ends in 2 may be written to mini-MOB file 2₂, and so on. For such an embodiment, there would therefore be N×10 mini-MOB files.

Other algorithms may also be used to segment the mini-MOB files. For example, the digits in the Investor ID may be added up, and the digits of the resulting sum may be repeatedly added until there is just a single digit number. Another possible algorithm is to perform a modular operation on the binary number representing the Investor ID. Also, hash algorithms may be used to segment the data. Also, a look-up function may be used to segment the data. For example, bid data from bidders whose Investor ID starts with a particular digit or string of digits may be assigned to a specific data stripe.

In addition, all of the mini-MOB files 72 that are grouped together using the algorithm (for example, all of the mini-MOB files containing bid data from investors having the same last digit of their investor ID) may be grouped in a separate directory file (or stripe) 74. In that way, all of the bids with the same algorithm result (e.g., all bids with same range of investor IDs) may be stored in the same directory file 74 regardless of syndicate member. As such, parallel-processing techniques can be used to more robustly analyze the bid data. Individual processors or groups of processors may analyze the separate directory files 74.

For example, referring to FIG. 1, the de-duplication system 40 may comprise a number of processors. Each processor may analyze the bid data from a separate directory file 74 to look for duplicative bids, i.e., bids from the same investor that have the same combination of price and quantity. Because the bid data may be striped according to a truncation algorithm based on the investor ID (assuming, for example, that one investor never has more than one investor ID), all bids from a particular investor will be in the same stripe. That way, the de-duplication system 40 only needs to analyze one stripe to detect duplicative bids by an investor whose Investor ID algorithm result puts all of the investor's bids in one data stripe.

The data striper 62 may be implemented as one or a number of networked computing devices or processors that execute software code that manages the data striping process. The software code may use any type of suitable computer instruction type, such as, for example, Java, C, C++, Sybase, Visual Basic, etc., using, for example, conventional or object-oriented techniques. The software code may be stored as a series of instructions or commands on a computer-readable medium, such as a random access memory (RAM), a read-only memory (ROM), a magnetic medium such as a hard drive or a floppy disk, or an optical medium such as a CD-ROM.

A bid aggregation system may aggregate the striped bid data in the bid repository 36. The bid aggregation system may perform multiple levels of aggregation and may be implemented as a number of computing or processing devices acting in parallel on the bid data to perform the aggregations. FIG. 4 illustrates how the bid aggregation system 100 may operate according to various embodiments of the present invention. The bid aggregation system 100 may first perform a level 1 aggregation on the mini-MOB files 72 in each directory file 74. The bid aggregation system 100 may perform the level 1 aggregation using different combinations of attributes of the bid data to thereby generate a number of first level aggregation files 110. According to various embodiments, in a multiple segment auction, one of the attributes considered may be the investor segment of the potential investor making the bid. The data for each attribute combination may be stored in a separate first level aggregation file 110. For example, if five attributes are used (e.g., attributes A, B, C, D, E), the bid aggregation system may perform an aggregation of the bid data for each combination of the five attributes (or 2⁵=32 combinations). The first file 110 may be an aggregation across attribute A, the second file 110 may be an aggregation across the combination of attributes A-B, the third file may be an aggregation across A-B-C, and so on. For performance reasons, the A-B aggregation may be built from the A-B-C aggregation, and the A aggregation may be built from the A-B aggregation, and so on. In order to more robustly aggregate the potentially voluminous bid data, a separate processor or group of processors of the bid aggregation system 100 may process each group (or directory file 74) of mini-MOB files 72. According to various embodiments, the bid aggregation system 110 may use hash tables or SQL to perform the first level aggregation.

The aggregation data in each first level aggregation file 110 may yield a demand curve for the particular attribute combination. For example, according to one variation, the attributes may be (1) syndicate member, (2) road show participation, (3) investor type or segment (e.g., institutional or individual), (4) price range (e.g., a range such as $25 and higher), and (5) sweep job (e.g., last completed sweep job by the sweep engine 32). Thus, the first level aggregation file 110 may yield the demand curve from potential investors bidding through “syndicate member 1” for the first investor ID stripe (e.g., the mini-MOB files 72 of the first data stripe 74). The demand curve may show the number of shares bid for at particular prices. The aggregation data may also include the number of bidders, as well as the maximum bid and minimum bid. Table 3 below illustrates a simplified, theoretical example of a first level aggregation file 110 for an aggregation based on syndicate member and bid price level.

TABLE 3

| | Price | No. of | No. of | | |
|---|---|---|---|---|---|
| Syndicate Member | ($) | Bidders | Shares | Min. Bid | Max. Bid |
| Syndicate Member 1 | 25.00 | 110 | 4000 | 25.00 | 27.00 |
| Syndicate Member 1 | 26.00 | 100 | 3000 | 26.00 | 27.00 |
| Syndicate Member 1 | 27.00 | 90 | 2500 | 27.00 | 28.00 |
| Syndicate Member 2 | 25.00 | 224 | 40,450 | 25.00 | 28.00 |
| Syndicate Member 2 | 26.00 | 190 | 35,000 | 26.00 | 28.00 |
| Syndicate Member 2 | 27.00 | 150 | 25,000 | 27.00 | 31.00 |

. . .

| | | | | | |
|---|---|---|---|---|---|
| Syndicate Member N | 25.00 | 350 | 25,000 | 25.00 | 30.00 |
| Syndicate Member N | 26.00 | 400 | 20,000 | 26.00 | 30.00 |
| Syndicate Member N | 27.00 | 500 | 15,000 | 27.00 | 32.00 |

Similar demand curve data may be generated for each of the first level aggregation files. Because, in various embodiments, the mini-MOB files 72 are striped according to an algorithm based on an identifier for the bidder/investor, the first level aggregation files 110 may contain the aggregation for the particular attribute combination for the corresponding investor ID stripe. This enables the unique number of bidders to be correctly determined.

Next, as shown in FIG. 4, the bid aggregation system 100 may perform a second level aggregation of the first level aggregation files 110. That is, the bid aggregation system 100 may aggregate all the data from all of the first level aggregation files 110 for a particular attribute combination. As a result, according to various embodiments, the data from each of the investor ID range may be aggregated for each attribute combination. The aggregated data may be stored in corresponding second level aggregation files 120. Table 4 below is a simplified, theoretical example of a second level aggregation file 120 for an aggregation based on syndicate member and bid price level. The data is similar to the sample first level aggregation file of Table 3, except that the number of bidders and the number of shares bid are greater due to the fact that the second level aggregation covers all of the investor ID stripes, rather than just one investor ID stripe as in the first level aggregation files.

TABLE 4

| | Price | No. of | No. of | Min. | |
|---|---|---|---|---|---|
| Syndicate Member | ($) | Bidders | Shares | Bid | Max. Bid |
| Syndicate Member 1 | 25.00 | 1100 | 40,000 | 25.00 | 28.00 |
| Syndicate Member 1 | 26.00 | 1000 | 30,000 | 26.00 | 28.00 |
| Syndicate Member 1 | 27.00 | 900 | 25,000 | 27.00 | 28.00 |
| Syndicate Member 2 | 25.00 | 2240 | 404,500 | 25.00 | 31.00 |
| Syndicate Member 2 | 26.00 | 1900 | 350,000 | 26.00 | 31.00 |
| Syndicate Member 2 | 27.00 | 1500 | 250,000 | 27.00 | 31.00 |

. . .

| | | | | | |
|---|---|---|---|---|---|
| Syndicate Member N | 25.00 | 3500 | 250,000 | 25.00 | 32.00 |
| Syndicate Member N | 26.00 | 4000 | 200,000 | 26.00 | 32.00 |
| Syndicate Member N | 27.00 | 5000 | 150,000 | 27.00 | 32.00 |

In this way, the system can generate a demand curve at the syndicate member level and price level combination, as shown above, or another combination of attributes, or a single attribute. Again, in order to increase system robustness, a separate processor or group of processors of the bid aggregation system 100 may perform the second level aggregation for each separate attribute combination. Where, for example, five attributes are used in the first level aggregation, corresponding to thirty-two (32) first level aggregation files 110 for each stripe, there would correspondingly be thirty-two second level aggregation files 120. The second level aggregation files 120 may be bulk copied into an aggregations database 124. The aggregations database 124 may be part of the bid repository 36, or it could be its own database(s). Again, hash tables or SQL may be used for the second level aggregations.

In other embodiments, the data could be partitioned even further if appropriate by performing additional, higher levels of aggregation. Also, if that data is “lopsided”, e.g., a relatively large number of bids are segmented into a relatively small number of stripes, then additional levels of aggregation may be used for the lopsided stripes. Grid computing solutions may be used for this process.

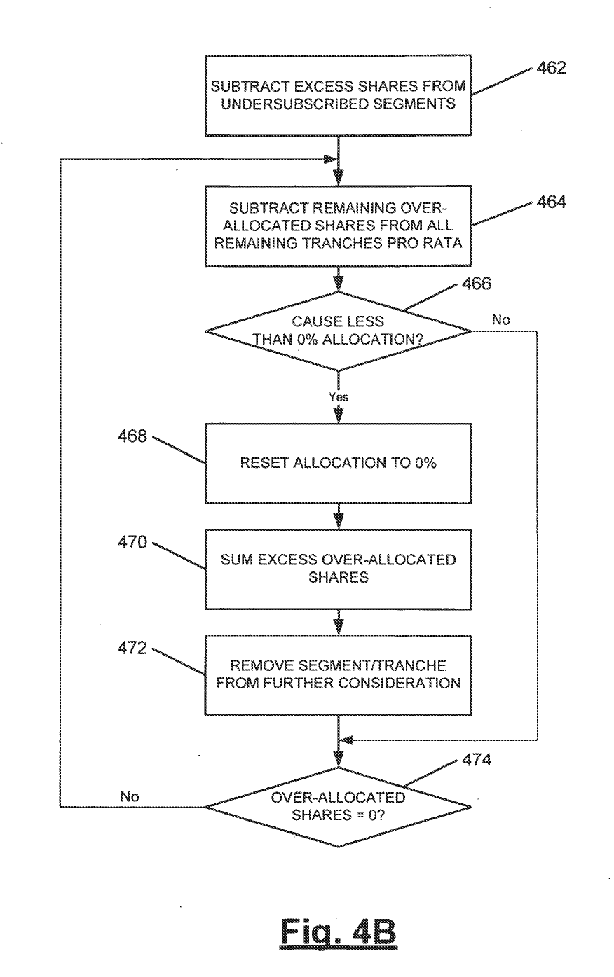

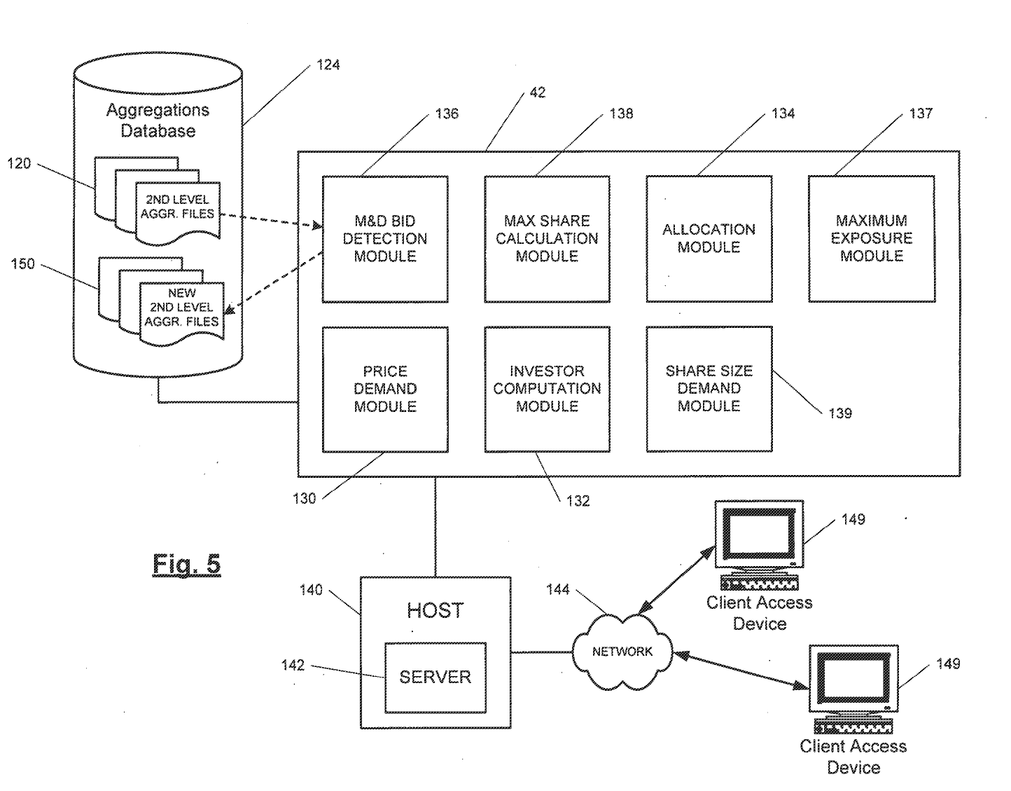

FIG. 5 is a block diagram of the analytics system 42 according to various embodiments. As illustrated in FIG. 5, the analytics system 42 may comprise a price demand module 130, an investor computation module 132, an allocation module 134, a manipulative and disruptive (M&D) bid detection module 136, a max share calculation module 138, a share size demand module 139, and a max exposure module 137. The modules may analyze the aggregate bid data, such as the bid data in the second level aggregation files 120 stored in the aggregations database 124, to provide analytics for users of the system 42 for trial allocations and other analysis of the offering, as described below.

Also as shown in FIG. 5, the auction management system 10 may include a host computing device 140 (referred to hereinafter as the “host”). The host 140, which is shown as a single device in FIG. 5 but which may be embodied as a series of networked computing devices, may include a server 142 for generating web pages based on the analytics generated by the analytics system 42. The server 142 may serve the generated web pages via a communications network 144, such as the Internet or an intranet, to registered users (such as the syndicate members and/or the issuing company) at client access devices 149 (such as personal computers, for example). In such a way, the users of the auction management system 10 may have, for example, web-enabled access to the analytics information generated by the analytics system 42. As described in more detail below, through a user interface provided by the host 140, users may input parameters to the analytics system 42 for trial allocations and/or investor computation analysis. The host 140 may receive the parameters and return output data computed by the analytics system 42 to the user via the network 144.

The analytics system 42 may be implemented as one or a number of networked computing devices, such as personal computers or servers. The modules 130-139 may be implemented as software code to be executed by a processor(s) (not shown) of the analytics system 42 using any type of computer instruction type suitable, such as, for example, Java, C, C++, Sybase, Visual Basic, etc., using, for example, conventional or object-oriented techniques. The software code may be stored as a series of instructions or commands on a computer-readable medium, such as a random access memory (RAM), a read-only memory (ROM), a magnetic medium such as a hard drive or a floppy disk, or an optical medium such as a CD-ROM.

The M&D bid detection module 136 may generate a number of M&D bid files (e.g., 1, 2, 5, etc.) for each second level aggregation file 120. The M&D bid files may list potentially manipulative or disruptive bids based on criteria designed to detect such bids. There are a number of different criteria that may be used to detect manipulative or disruptive bids. For example, the M&D bid detection module 136 may analyze the dispersion in the aggregate bid data in (i) price, (ii) number of shares, (iii) number of bids, (iv) the maximum exposure (described further below), and/or (v) the distribution of bid prices from a bidder (e.g., every penny versus every dollar; low/high prices versus prices clustered in middle of price range, etc.) to detect outliers. The outliers may be considered to be manipulative and/or disruptive bids, and those bids may be listed in the M&D bid files. A number of such M&D bid files may be built for each second level aggregation file 120, each M&D bid file having, for example, different criteria for detecting manipulative/disruptive bids. For example, one M&D bid file may contain M&D identified bids based on the number of shares bid, and a second M&D bid file may contain M&D bids identified based on price, etc. The criteria may be input by a user or default criteria may be used.

In addition, the M&D bid detection module 136 may analyze a bidder's behavior over time to detect potentially manipulative or disruptive bids. For example, changes in the demand curve of a particular bidder over time may be indicative of a manipulative pattern. For example, if the shift in the bidder's demand is in accordance with the preponderance of the behavior by other like investors, or if the shift is expected, the bids may be deemed not to be manipulative or disruptive. On the other hand, other bidding patterns, such as very high price bids early in the bidding, followed by splitting demand between low and high prices later in the auction may be deemed to be a manipulative pattern. Other criteria may also be used to identify manipulative patterns. Also, similarity detection may be used across the bidding behavior of groups of bidders to detect potentially collusive bidding.

In various embodiments, M&D bid detection module 136 first compiles a list of bids identified as potentially manipulative/disruptive. Then, the syndicate members who submitted the manipulative/disruptive bids may be actively contacted to determine whether the bids are accurate or not. If the identified bids are determined to be accurate (e.g., no clerical input errors), the bids may be assumed to be manipulative/disruptive. In other embodiments, computer automation may be used to reject the bids identified as manipulative/disruptive.

The M&D bid detection module 136 may subtract the M&D bid files from their corresponding second level aggregation files 120 to generate a number of new second level aggregation files 150. The new second level aggregation files 150, therefore, would correspond to the prior second level aggregation files 120 but with the identified manipulative/disruptive bids removed. For each original second level aggregation file 120, there would be a corresponding number of new second level aggregation files 150 depending on the number of M&D bid files generated for each original second level aggregation file 120. For example, if two M&D bid files were built for each original second level aggregation file 120 (corresponding to different criteria for identifying M&D bids), there would be two new second level aggregation files 150 for each original second level aggregation file 120, and so on. Thus, for example, if there were thirty-two original second level aggregation files 120 and two M&D bid files were generated for each original second level aggregation file, there would be sixty-four new second level aggregation files 150.

The price demand module 130 may interpolate the bid data (such as from the new second level aggregation files 150) to generate an aggregate price demand curve. The price demand curve data may be generated by determining the number of shares requested at each price in the range of possible bid prices. To generate the number of shares bid at each price, a cumulative approach may be used. That is, for example, the aggregate demand at any particular price point may be assumed to be the sum of the demand at the particular price point plus the demand at each greater price point. For example, assume the aggregate bid data shown in Table 5.

TABLE 5

| Price ($) | Number of Shares Bid |
|---|---|
| 10.00 | 2000 |
| 11.00 | 1250 |
| 12.00 | 900 |
| 13.00 | 850 |
| 14.00 | 800 |
| 15.00 | 1500 |
| 16.00 | 1200 |
| 17.00 | 1100 |
| 18.00 | 900 |
| 19.00 | 800 |
| 20.00 | 1250 |

In this example, the aggregate demand data would be that shown in Table 6 and graphically represented in FIG. 6.

TABLE 6

| Price ($) | Number of Shares | Aggregate Demand |
|---|---|---|
| 10.00 | 2000 | 12,550 |
| 11.00 | 1250 | 10,550 |
| 12.00 | 900 | 9300 |
| 13.00 | 850 | 8400 |
| 14.00 | 800 | 7550 |
| 15.00 | 1500 | 6750 |
| 16.00 | 1200 | 5250 |
| 17.00 | 1100 | 4050 |
| 18.00 | 900 | 2950 |
| 19.00 | 800 | 2050 |
| 20.00 | 1250 | 1250 |

As can be seen, the aggregate demand at $19.00 corresponds to the number of shares bid at $19 plus the number of shares bid at $20; the aggregate demand at $18.00 corresponds to the number of shares bid at $18, in addition to the number of shares bid at $19 and $20, and so on.

In the illustrated example, the price points are whole dollar amounts. Of course, in a practical implementation, bids may be placed on the cent level or some other increment (5 cents, 10 cents, etc.). Also, the numeric range of the bids may be different than $10 to $20. From the demand curve of FIG. 6, it can be seen that if the issuing company wishes to issue 8,400 shares, the clearing price would be $13.00 for this example. The price demand module 130 may generate such a price demand curve for each of the second level aggregation files, or a subset of the files, for example.

The investor computation module 132 may determine the number of investors/bidders at each price point (i.e., the aggregate number of investors for each price point). Recall that in certain auctions, an investor may be able to submit multiple bids, each having a different combination of price and quantity. According to one embodiment, the ability of investors to submit multiple bids may be treated in the determination of the number of investors per price bid by counting a bidder once at every price point up to the highest bid by the investor. For example, assume bidders A through E placed bids as shown in the example of Table 7 below. That is, investor A submitted bids at $14, $17 and $20, investor B submitted bids at $15 and $19, and so on.

TABLE 7

| | Price | | | | | | | | | | |
|---|---|---|---|---|---|---|---|---|---|---|---|
| Investor | $10 | $11 | $12 | $13 | $14 | $15 | $16 | $17 | $18 | $19 | $20 |
| A | 0 | 0 | 0 | 0 | 1 | 0 | 0 | 1 | 0 | 0 | 1 |
| B | 0 | 0 | 0 | 0 | 0 | 1 | 0 | 0 | 0 | 1 | 0 |
| C | 1 | 0 | 0 | 0 | 0 | 0 | 0 | 0 | 0 | 0 | 0 |
| D | 0 | 0 | 0 | 0 | 0 | 1 | 0 | 0 | 0 | 0 | 1 |
| E | 0 | 0 | 0 | 1 | 0 | 1 | 0 | 1 | 0 | 0 | 0 |

In that case, the investor computation module 132 may count the bids of the various bidders once at each price point up to the highest bid for the respective bidder, so that the corresponding demand table for this example would be as shown in Table 8.

TABLE 8

| | Price | | | | | | | | | | |
|---|---|---|---|---|---|---|---|---|---|---|---|
| Investor | $10 | $11 | $12 | $13 | $14 | $15 | $16 | $17 | $18 | $19 | $20 |
| A | 1 | 1 | 1 | 1 | 1 | 1 | 1 | 1 | 1 | 1 | 1 |
| B | 1 | 1 | 1 | 1 | 1 | 1 | 1 | 1 | 1 | 1 | 0 |
| C | 1 | 0 | 0 | 0 | 0 | 0 | 0 | 0 | 0 | 0 | 0 |
| D | 1 | 1 | 1 | 1 | 1 | 1 | 1 | 1 | 1 | 1 | 1 |
| E | 1 | 1 | 1 | 1 | 1 | 1 | 1 | 1 | 0 | 0 | 0 |
| Total Number of | 5 | 4 | 4 | 4 | 4 | 4 | 4 | 4 | 3 | 3 | 2 |
| Unique Bidders | | | | | | | | | | | |

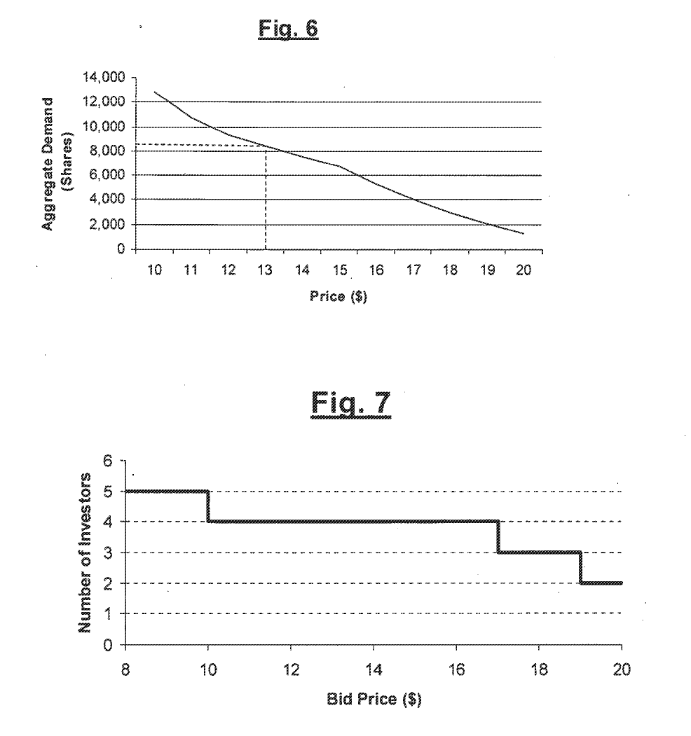

FIG. 7 shows the corresponding curve for the number of investors at each price point. Each investor is counted at every bid price increment up to the highest bid price for the investor (so-called “back-filling”). Therefore, the number of investors at $20 is two in this example (investors A and D). The demand at $19 is three (investors A, B and D), and the demand at $17 is four (investors A, B, D and E). Notice that investor A is not recounted at $17 because investor A is counted only once at each bid increment up to investor A's highest bid, which is $20 in this example for investor A. In this manner, the investor computation module 132 may generate the curve showing the number of investors at each price point. The investor computation module 132 may generate such a curve for each of the second level aggregation files, or a subset of the files.

The share size demand module 139 may compute the number of bidders versus the share lots for the bids at particular price points. That is, for a particular bid price ($x), the share size demand module 139 may determine the number of bidders who requested each possible share size lot. The prices at which the share size demand module 139 may do this computation may span the entire range of bid prices, or a subset of the bid price range. In that way, the share size demand module 139 may determine the number of bidders who bid $x at each permissible share lot size in the auction over the range of permissible share lot sizes (e.g., 1 share to 10 million shares). In other words, the share size demand module 139 may generate a histogram to show the number of bidders for each share lot size at a particular price point. The share size demand module 139 may generate a number of such histograms, covering a range of bid prices. The histogram data for each bid price increment may be stored in a separate file so that it may be quickly accessed when requested by a user.

For bid aggregation purposes, to increase the computation speed associated with the system, the quantity bids may be bucketized into various bid size buckets (which may not necessarily match the allowable bid size increments in the auction). For example, the buckets for bid sizes between 1 and 999 shares may be 1; for bids sizes between 1000 and 10000 shares the buckets may be in steps of 100 shares (e.g., buckets of 1000, 1100, 1200, and so on); for bids sizes between 10,000 and 100,000 shares, the buckets may be in steps of 1000 shares; for bid sizes between 100,000 and 1,000,000, the buckets may be in steps of 10,000 shares; and for bid sizes between 1,000,000 and 10,000,000, the buckets may be in steps of 100,000 shares. In various embodiments, no bids over 10,000,000 shares may be permitted in the auction. Such a bucket format limits the number of allowed share lots (or buckets) for bid aggregation purposes. Limiting the number of share lots (or buckets) may correspondingly decrease the computation time by the share size demand module 139 (and the other modules) in analyzing the bid data. The share size demand module 139 may compute the number of bidders versus the share lots for each of the second level aggregation files, or a subset of the files. It should be noted that the buckets used for bid aggregation purposes need not be used nor correspond to the permissible bid sizes in the auction for allocation purposes; the allocation module 134 may compute the allocation in share sizes that correspond to share sizes that are permissible in the auction.

The max share calculation module 138 may calculate the maximum share allocation for a particular supply (S) of securities to be offered at a particular offering price (P). In a maximum share allocation approach, winning bidders who have bid for a number of shares less than or equal to the maximum share allocation get the amount they bid, and winning bidders who bid for a greater number of shares get the maximum share allocation, subject to the rounding algorithm described above. A user of the auction management system 10 may set the supply S and the offering price P for trial allocations via the user-interface provided by the host 140.

The max share calculation module 138 may calculate the max share amount for offerings where only certain share size buckets are possible as quantity bids (see above description) or it may calculate the max share amount on a per-share level where a bidder may submit a quantity bid of any share size (or any share size between the minimum and maximum allowed amounts). To speed up the calculation of the max share amount, a separate file may be used to store the bid data for each bid price increment (e.g., $15 to $25 by increments of 10, 100, etc.). Within each such file, the max share calculation module 138 may sort the bids according to size (i.e., number of shares requested). The max share calculation module 138 may then compute the max share amount for each file for a given supply. In that way, when a user inputs a price and supply for a trial allocation, the max share calculation module 138 only needs to retrieve the relevant price file in order compute the max share amount, thereby potentially reducing computation time.

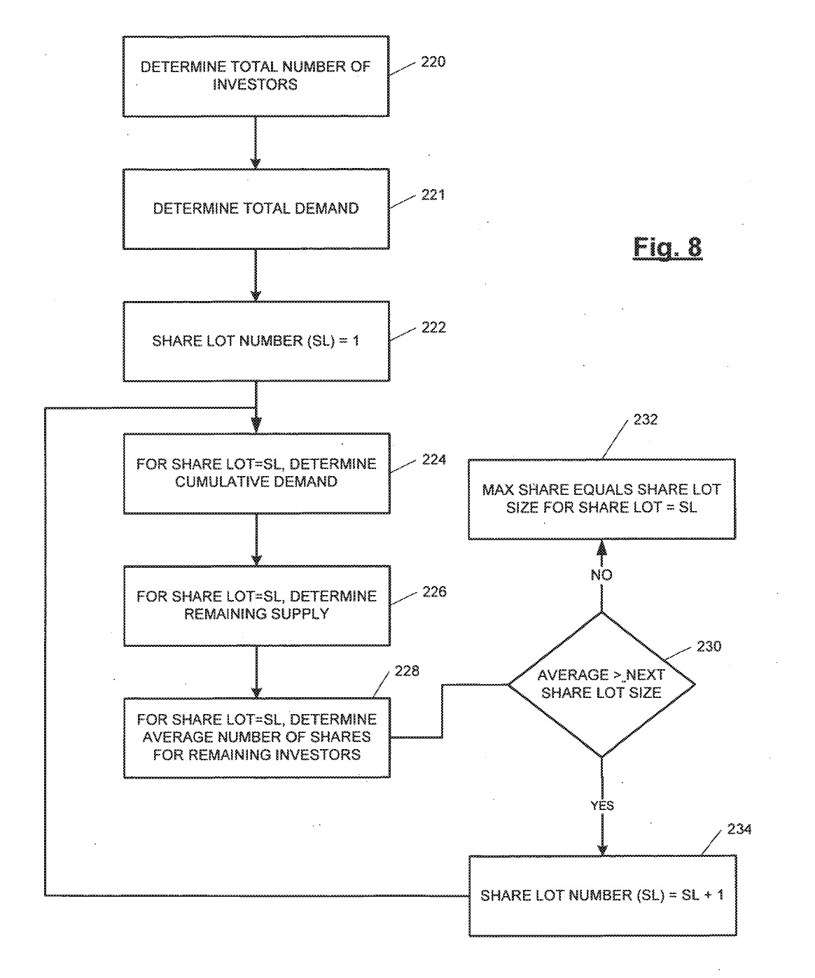

FIG. 8 is a diagram of the process flow through the max share calculation module 138 according to various embodiments of the present invention for calculating the max share amount for a given supply (S) at a particular price (P). At step 220, the total number of investors (i.e., winning bidders) at the share price may be determined. Every investor who bid at or above the selected offering price P is considered a winning bidder (with the exception that bidders who made manipulative/disruptive bids may be excluded).

Next, at step 221, the demand or number of shares bid for by each winning bidder is determined. For bidders who made only one bid at or above the offering price, the number of shares for those investors corresponds to the number requested in that one bid. For bidders who submitted multiple bids at or above the selected offering price, a number of different approaches may be used to determine the number of shares bid for by such winning bidders. According to one approach, the bidder is assumed to have requested the number of shares for the winning bid price that is closest (and necessarily equal to or greater than) the offering price. For example, assume Bidder A makes three bids as shown below:
300 shares at $20
100 shares at $25
200 shares at $30
   If the selected offering price is $22, then Bidder A may be assumed to have requested 100 shares in this approach because $25 is the closest winning bid by Bidder A to the selected offering price and Bidder A requested 100 shares at $25.

According to a second, “cumulative” approach, winning bidders are assumed to have requested the sum of all shares requested for all winning bids by the bidder. Thus, in the above example, Bidder A would be assumed to have requested 300 shares at an offering price of $22, calculated as 100 shares for the winning bid of $25 and 200 shares for the winning bid of $30. Either approach, or potentially other approaches, may be used at step 221 to determine the number of shares requested by the winning bidders.

Next, at step 222, the share lot number (SL), i.e., the ordinal number or counter for the share lots (not necessarily the number of shares in the share lot size), is set equal to one, corresponding to the first share lot.

Next, at step 224, the cumulative demand for the SL^{th} share lot (e.g., the first share lot when SL=1) is determined. The cumulative demand corresponds to the demand for the SL^{th} share lot (which equals the number of investors who requested a number of shares equal to the size of the share lot times the size of the share lot) plus the demand for each smaller share lot. That is, the cumulative demand for the i^{th} share lot corresponds to

$${\sum }_{i = 1}^{SL} {D}_{i} ,$$

where Dᵢ is the demand for each respective share lot (see FIG. 7 and Table 8). At step 226, the remaining supply is determined. The remaining supply corresponds to the supply (which may be entered by the user via the user interface) minus the cumulative demand (i.e.,

$$S - {\sum }_{i = 1}^{SL} {D}_{i} ) .$$

Next, at step 228, the average number of shares for the remaining investors is determined. This average (A) corresponds to the ratio of the remaining supply to the remaining number of investors. The remaining number of investors corresponds to the total number of winning investors minus the number of investors for each share lot up to and including the SL^{th} share lot. Thus, if, for example, there were 1000 winning bidders and the number of winning bidders accounted for in a share lot up to and including the SL^{th} share lot is 650, then there are 350 remaining investors in this example. Next, at step 230, a determination is made of whether the average number of shares for the remaining investors for the SL+1^{th} share lot (A_{SL+1}) is greater than the share lot size for the next (SL+1^{th}) share lot. If so, the process advances to step 234, where the counter SL is incremented by one and the process returns to step 224, where the process is repeated for the next (SL+1^{th}) share lot. On the other hand, if the average number of shares for the remaining investors is not greater than the share lot size for the next share lot size, the process advances to step 232 where the maximum share allocation is determined to correspond to the size of the SL^{th} share lot.

The following is a simplified, numerical example of how the max share calculation may operate. Suppose the supply of shares (S) is thirty shares and the bid data at the requested offering price P is as shown in Table 9 below.

TABLE 9

| | Size of Share | | | | Average for |
|---|---|---|---|---|---|
| Share Lot | Lot (# of | No. of | Cum. | Remaining | Remaining |
| No. (SL) | Shares) | Investors | Demand | Supply | Investors |
| 1 | 1 | 2 | 2 | 28 | 2.54 |
| 2 | 2 | 3 | 8 | 22 | 2.75 |
| 3 | 3 | 3 | 17 | 13 | |
| 4 | 4 | 4 | 33 | −3 | |
| 5 | 5 | 1 | 38 | −8 | |

In this example, at step 220, the total number of investors is determined to be thirteen (13) (calculated by summing the entries of col. 3). At step 224, for the first share lot, the cumulative demand is calculated, which corresponds to two (2) in this example, calculated by multiplying two investors by 1 share each. Next, at step 226, the remaining supply is computed, which is 30−2=28, and at step 228 the average number of shares for the remaining investors is determined to be 28/(13−2)=2.54. Thus, because the average (2.54) is greater than the size of the next share lot size (the share lot size for the second share lot is two (2) shares), the process is repeated for the second share lot.

In repeating the process for the second share lot size, the cumulative demand is determined at step 224 to be 8, calculated as 6 for the second share lot plus 2 for the first share lot. The remaining supply is 22 and, therefore, the average for the remaining investors is 22/(13−5)=2.75. Because the average (2.75) is less than the size of the next share lot size (the share lot size for the third share lot is three (3) shares), the maximum share allocation in this example is two shares. Thus, the investors in the first share lot get one share, and the investors in each of the subsequent share lots get two shares (subject to rounding of fractional shares).

The allocation module 134 may determine the allocation to successful bidders given a specified price, supply and allocation scheme. That is, as described in more detail below, a user of the analytics system may input a price, a supply and an allocation scheme (e.g., pro rata, max share, a hybrid of the two, etc.) and the allocation module 134 may compute the allocation to the winning bidders. In this way, a user could evaluate the allocations for different trials of price, supply and allocation scheme. The allocation module 134 may use a rounding algorithm, such as the store-based rounding approach described above, for the chosen allocation scheme.

In addition, the allocation module 139 may compute the allocation for each successful bidder on a bidder-account level. That is, in some instances, the same investor may participate in the auction through multiple accounts. The initial allocation, such as according to either the max share or pro rata approach, of the offered shares may be on the investor level (e.g., Investor A is allocated 10,000 shares). In order to allocate down to the account level, according to various embodiments, the number of shares allocated to the investor may be spread pro rata across the various accounts of the investor used to submit bids in the auction. That is, for example, if Investor A submitted bids for three different accounts, the allocation module 139 may spread Investor A's allocation of 10,000 shares across the three accounts. According to one embodiment, the allocation down to the investor-account level may use a pro rata approach; that is, the investor's allocation is spread pro rata across the investor's accounts. Such pro ration may lead to fractional shares. One mechanism to deal with the fractional shares is to sum all of the fractional parts in advance. This total remainder R will be by definition less than the number of accounts. An additional share may be assigned to R of the investor's accounts.

The max exposure module 137 may compute the maximum (“max”) exposure for a bidder. To calculate a bidder's max exposure, the max exposure module 137 computes the bidder's exposure at each bid price by multiplying the bid price times the number of shares demanded at the bid price (recalling that the shares demanded at bid prices greater than the subject bid price may be included in the demand for the subject bid price). The bidder's max exposure is the maximum of the exposures for the various bid prices. For example, suppose a bidder submits a series of bids as shown in Table 10 below.

TABLE 10

| Bid No. | No. of Shares | Bid Price | Max Exposure |
|---|---|---|---|
| 1 | 1000 | $50 | $50,000 |
| 2 | 100 | $40 | $44,000 |
| 3 | 500 | $35 | $56,000 |
| 4 | 1000 | $30 | $78,000 |

In this example, the bidder's exposure at $50 is $50,000, computed as 1000 shares demanded times $50 per share. The bidder's exposure at $40 is $4400, computed as 1100 shares demanded (i.e., counting the 100 shares bid at $40 and the 1000 shares bid at $50) times $40, and so on. In this example, the bidder's maximum exposure is $78,000.

Output of the analytics system 42 may be served to users via the network 144, such as by serving web pages to the user access devices 149 over a secure TCP/IP network. The users may be, for example, persons or representatives associated with the issuing company and/or the underwriters. Access to the web pages is preferably limited to users who are not eligible to participate in the auction.

The analytics system 42 may provide real time analysis to multiple concurrent, asynchronous users. In order to do this, according to various embodiments, the system 42 may poll the users to see if an analytical request has been made. If a request has been made, the system 42 will read the user inputs (e.g., price, supply, allocation, M&D criteria, etc.) and execute the requested analysis on the relevant bid data. In order to expedite the analytical calculations so that users of the analytics system 42 may obtain results in real time (i.e., within a small response time), the analytics system 42 may employ an indexed memory structure. According to various embodiments, the indexed memory structure may include a hierarchically organized system of files containing the bid data for each bid price increment in the range of acceptable bid prices. That is, for example, a file may be created for each bid price increment in the range, and those files may contain the demand profile for the particular bid price by listing the number of bids received at each share lot size. For example, the file for price P might show 3 bids of 100 shares, 5 bids of 120 shares, 8 bids of 150 shares, etc. The files may be organized in a hierarchical manner, such as, for example, based on the digits in the price, with the most significant digit being at the top of the hierarchy and the least significant digit at the bottom. In that way, when a user inputs a particular price (or price range) for trial allocation analysis, the modules of the analytics system 42 can quickly retrieve the corresponding price file(s) and do real-time analysis.

According to other embodiments, the indexed memory structure may include an indexed database structure or indexed memory cache structure that facilitates rapid retrieval of the bid data for the price increments used in the analysis.

The results from the analysis may be stored in a database and served to the user via the host 140. When a user's request has been completed, the system 42 may set the status flag for the request to “Done” and commence the next request job.

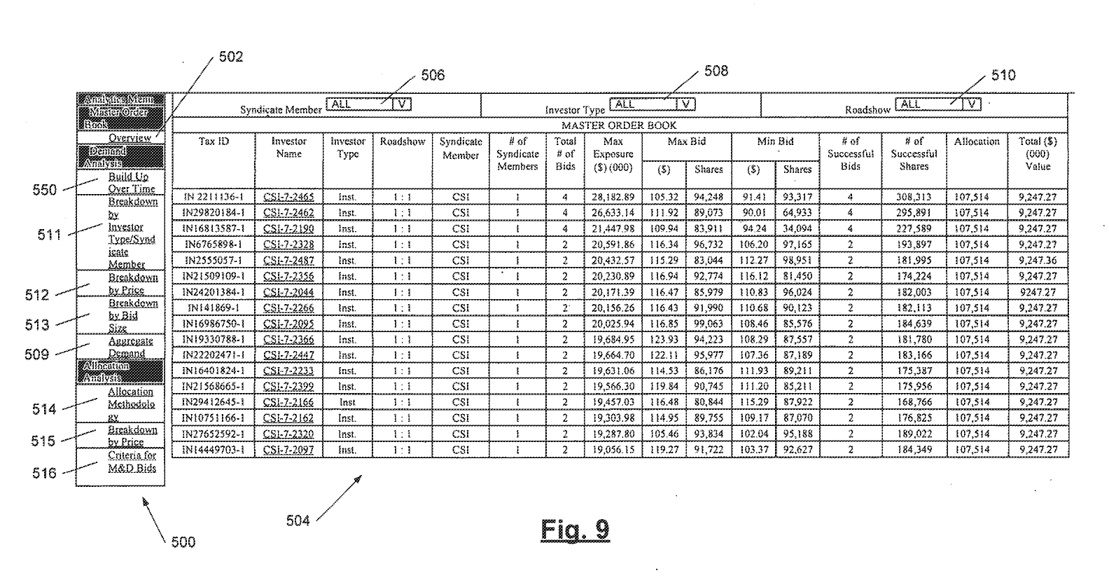

An interactive web page interface served to a user, such as shown in FIG. 9, may allow the user to specify the type of analysis that the user wishes to perform, such as run trial allocations or to analyze the demand of the auctioned securities among groups of bidders. Based on the user's request, the host 140 may serve other web pages that show the outcome of the analysis based on the user's inputs. For example, as shown in FIG. 9, the interface may include a display area 500 including an analytics menu. The analytics menu 500 may, for example, contain links to various analytical tools or links that allow the user to specify parameters for trial offerings. For example, the link 502 may provide a hyperlink to the Master Order Book (MOB), as shown in section 504 of the interface of FIG. 9. The menu 500 may also include demand analysis links and allocation analysis links, described further below. The demand analysis links also allow the user to analyze the auction demand in various ways. The allocation analysis links may allow the user to test a variety of allocation scenarios (sometimes referred to herein as “trial allocations”).

The MOB overview, as shown in FIG. 9, may allow the user to input choices for various attributes of the bidders for the offering. In response to the inputs, the analytics system 42 may compute the corresponding bid data analytics for bidders meeting the attribute settings and the results may be served to the user. For example, in field 506, the user may select, via, for example, a drop-down window or other known selection techniques, a particular syndicate member or group of syndicate members. The analytics system 42 would then run the analytics on the bids submitted with the selected syndicate member or members. For example, as shown in FIG. 9, the user may select “All” for all of the syndicate members. In field 508, the user may select, via, for example, a drop-down window, the investor type (e.g., retail, institutional, all). The analytics system 42 would then run the analytics on the bidders who satisfy the investor type setting as well. In field 510, the user may select, via, for example, a drop-down window, a road show participation setting. The road show participation setting may be “All,” as shown in FIG. 9 (meaning all the bid data from all investors are analyzed regardless of whether the investor attended a road show event or not), or the road show setting may indicate, for example, a one-to-one meeting with the management of the issuer, or a group meeting with the management and other potential investors.

The analytics system 42 may compile/analyze the bid data for bidders who satisfy the selected attribute parameters and the results may be served to the user in the chart display 504, as shown in FIG. 9. For each bidder that satisfies the attribute parameters, as shown in FIG. 9, the chart may identify attributes of the bidder, such as ID, name (a code name may be used), investor type (e.g., institutional, retail, etc.), whether and what type of road show the investor participated in, the number of syndicate members used, etc. The chart may also list, as shown in FIG. 9, the total number of bids submitted by the bidder, the maximum exposure of the bidder (as determined by the max exposure module 137), as well as the specifics (e.g., price and size) of the bidder's maximum and minimum price bids. In addition, the chart may list the number of successful bids of the investor at the selected offering price for the analysis (in this example, $86.01 per share), the number of shares requested by the bidder in those winning bids, the allocation to the various bidders (as determined by the allocation module 134), and the total value of the bidders' allocation (allocation times share price). In this example, a max share allocation approach was used where the max share amount was 107,514 shares. All of the listed bidders in this example received the max share amount. Other bidders, not listed in the figure, may receive less than the max share amount.

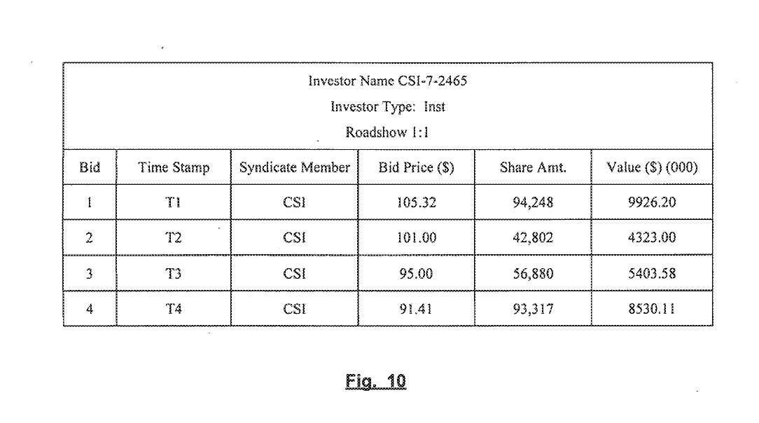

As can be seen in FIG. 9, the “Investor Name” for the respective bidders may contain a hyperlink to details about the respective bidders' bids. For example, as shown in FIG. 10, by clicking on the hyperlink for the investor name associated with a bidder, the details of each bid by the selected bidder, including the times the various bids by the bidder were placed, the syndicate member with whom the bids where placed, and the price and share amounts, may be displayed.

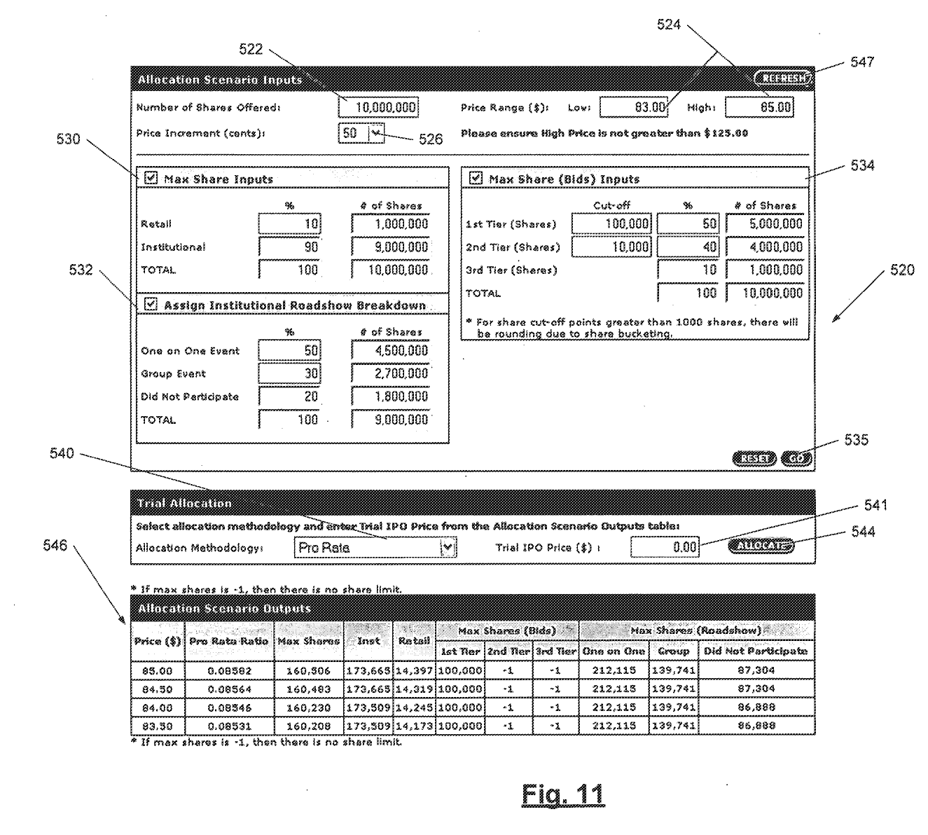

For allocation analysis, the parameters of the trial offerings may be set by the user with an interface 520 such as shown in FIG. 11, which may be displayed for the user by activating the link 514 on the menu 500 of the interface of FIG. 9. The interface 520 may include a field 522, where the user may enter the number of shares to be offered in the trial. In a field 524, the user may select an offering price range at which the trial allocations will be generated, with the price increment between the low and high prices of the range set at field 526. In field blocks 530, 532, 534, the user may select various allocation parameters if desired in the user's analysis. For example, in field block 530, the user may specify an allocation between different types of investors (e.g., retail and institutional). In this example, the user has selected a 10%-90% split in the allocation between retail and institutional investors. In field block 532, the user may, for example, further refine the allocation to institutional investors based on their road show participation. In field block 534, the user may tier (segment) the investor population by the cumulative number of shares they bid for. Two cutoffs are used in this example to define three tiers. For each tier, the user may then define the percentage of the total number of shares offered that should be assigned to each tier. If one tier is given a proportionally larger number of shares, then it is a way of increasing the max share value for that tier. Upon clicking the “GO” button 535, the max share module 138 would then calculate three max share values, one for each tier. The results from the analysis may be displayed in the table 546 at the bottom of the page when the “REFRESH” button 547 is activated.

In addition, after review of the results over the desired price range, the user can set a trial IPO price, at field 541, for a selected allocation approach, chosen from a drop-down window 540. For example, the user may choose whether a max shares allocation approach is used (as shown in the example of FIG. 11) or whether a pro rata approach is used. In other embodiments, the user may also select other possible options, such as max shares for institutional investors and pro rata for retail, and vice versa. By clicking on or otherwise activating the “ALLOCATE” icon 544, the allocation module 134 computes the allocations for the trial based on the inputs and parameters specified by the user.

The user may, of course, choose not to use the allocation options allowed by the field blocks 530, 532, 534 in the trials, or use only some of them. In other embodiments, different allocation refinement options may be available to the user.

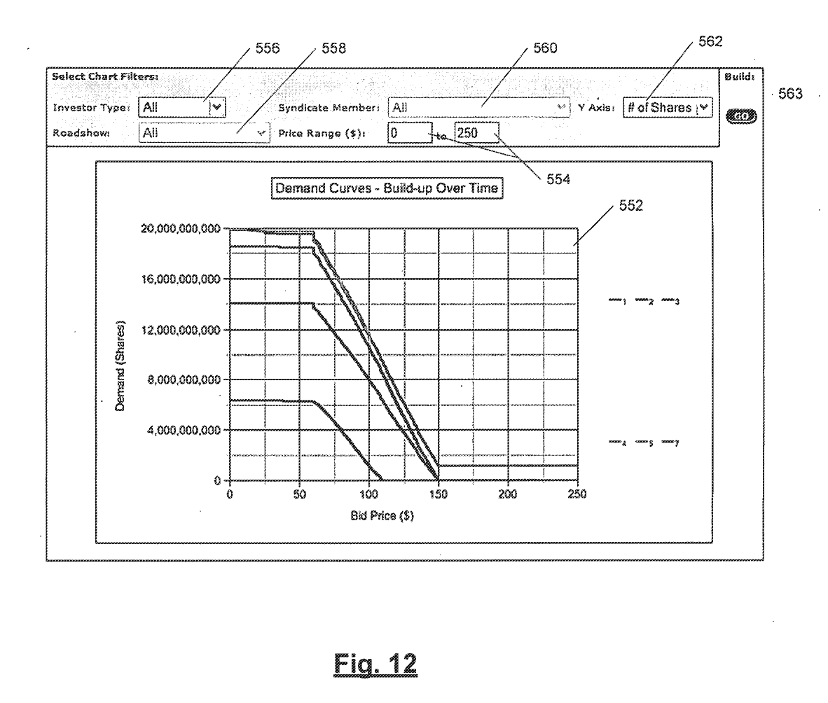

Returning to FIG. 9, the analytics menu 500 may also contain a number of options for analyzing the demand for the offered shares. For example, the analytics menu may contain a hyperlink 550 that allows the user to see the demand build up over time (e.g., sweep job) over the course of the auction in a graph, such as the graph 552 shown in FIG. 12. The user may select the price range for the graph from drop-down windows 554, or, in other embodiments, the user may be able to input a specific price range. Also, in drop-down windows 556, 558, 560, 562, the user may, for example, specify attributes of the investors for which the demand buildup is to be displayed. For example, in field 556 the user may select the investor type; in field 558 the user may select the road show participation attribute of the investors; in field 560 the user may select the syndicate member(s); and in field 562 the user may select the parameter for the y-axis in the graph. (In this example, the y-axis shows the number of shares; other options for the y-axis include the number of bids, for example). Once the user populates the fields with the desired attributes, the user may activate the “GO” icon 563 to request the analysis.

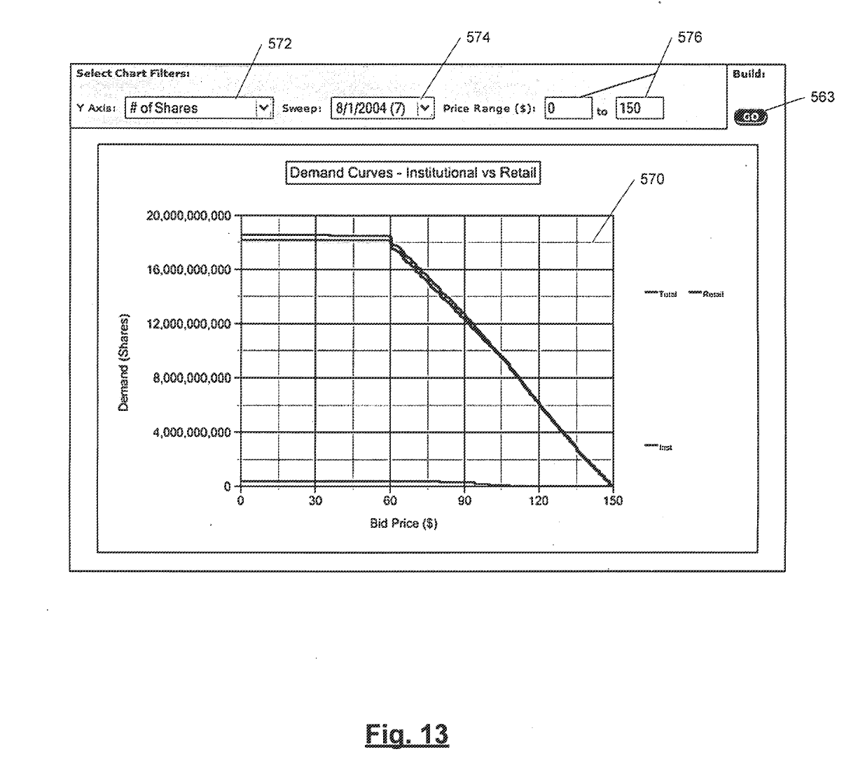

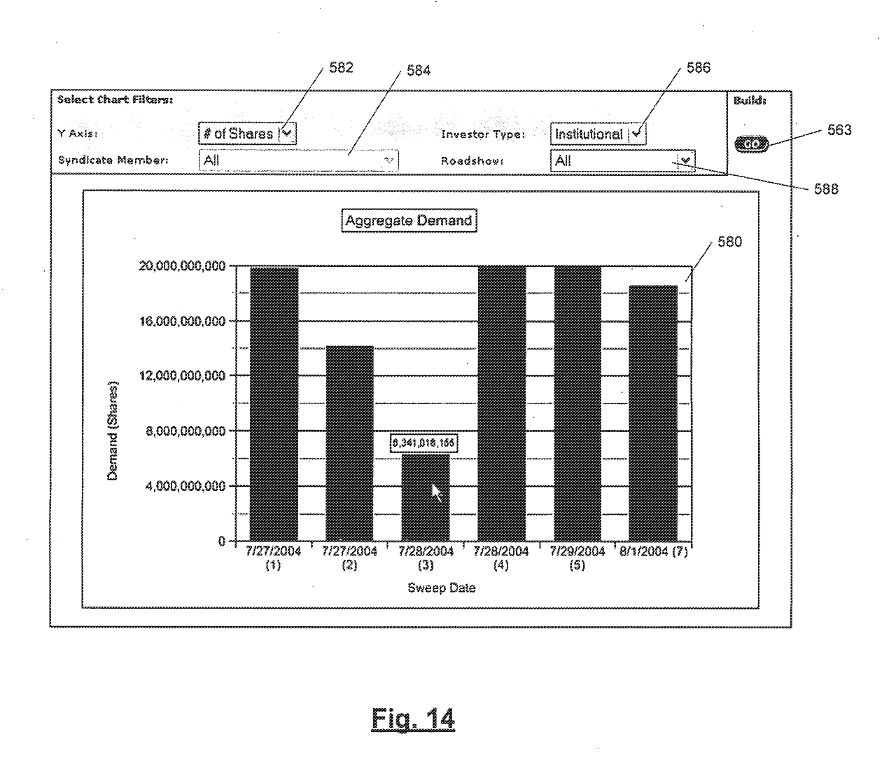

Also, returning to FIG. 9, the analytics menu may contain a link 511 for showing the demand breakdown by investor type or syndicate member. An example of the graphical output available when activating this link is shown in graph 570 of FIG. 13. In field 572 the user may specify the y-axis parameter; in field 574 the user may specify the sweep job; and in field 578 the user may specify the price range for the analysis. For the example of FIG. 13, the y-axis is selected to be number of shares, although other options may include number of bids and percent of offered shares. Selection of “percent of offered shares” provides a clearing price curve. Also, as shown in FIG. 14, a chart 580 showing the aggregate demand by sweep date may be displayed to the user. This chart may be displayed by activating the “Aggregate Demand” link 509 in the menu 500 of FIG. 9, and the chart 580 may show the maximum number of shares bid for by all investors by sweep job. In field 582 the user may specify the y-axis parameter (number of shares in this example; could also be number of bids); in field 584 the user may specify the syndicate member(s); in field 586 the user may specify the investor type; and in field 588 the user may specify the road show participation value for the analysis.

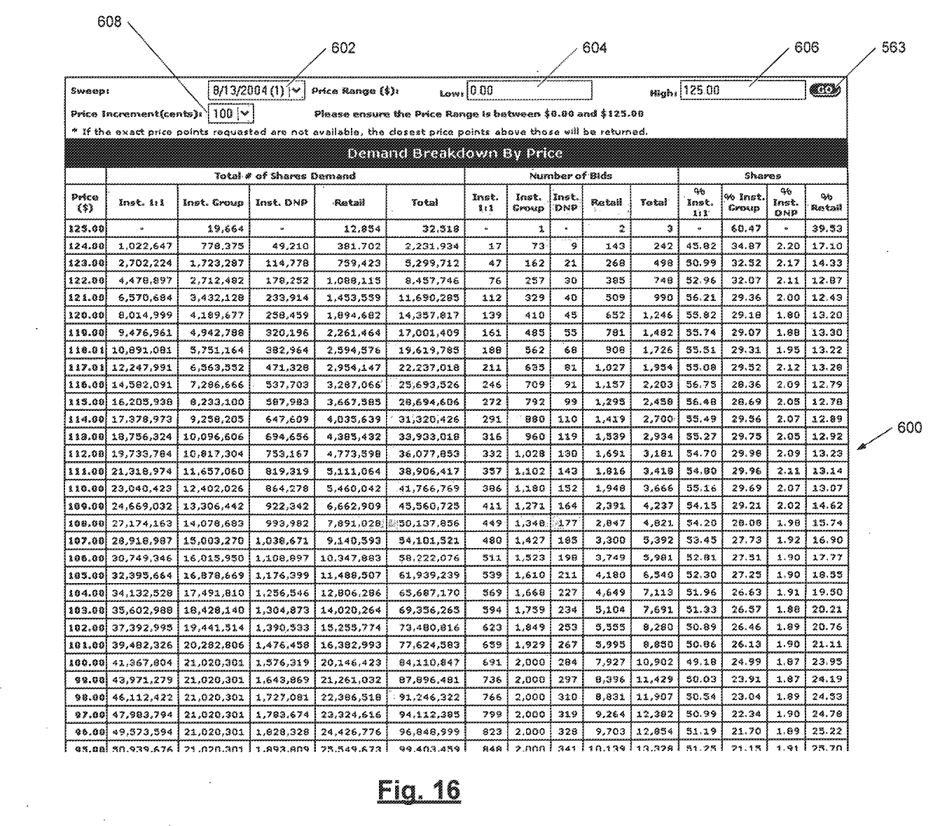

The interface of FIG. 9 may also include a link 512 for showing the share demand by price. An example of a chart display 600 showing such a breakdown by price is shown in FIG. 16. Such a chart 600 enables the user to identify the breakdown at each price point and according to various groups of investors. At field 602, the user may specify the sweep job; at fields 604, 606 the user may specify the price range; and at field 608 the user may specify the price increment. The price increment options may be, for example, 100 cents, 50 cents, 25 cents, 20 cents, 10 cents, 5 cents and 1 cent.

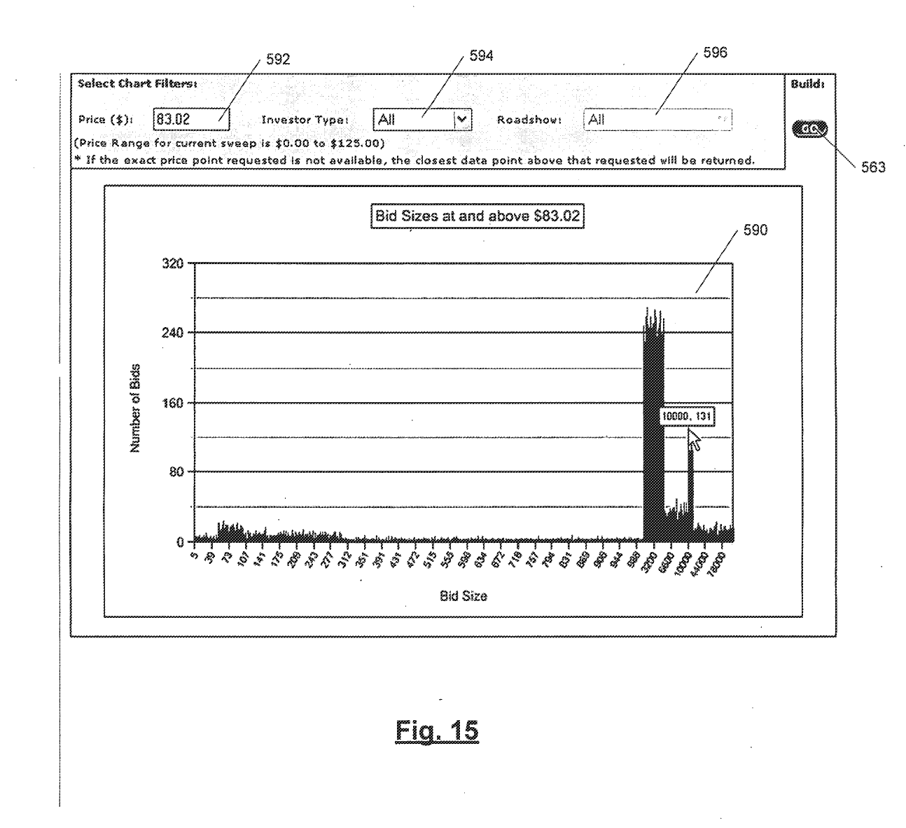

Returning to FIG. 9, the analytics menu 500 may also include a link 513 to analyze the number of bids as a function of bid size for a particular price. A graph 590 showing the number of bids as a function of bid size for an exemplary offering is shown in FIG. 15. In field 592 the user may specify the price for the analysis; in field 594 the user may specify the investor type; and in field 596 the user may specify the road show participation value.

Other analytics options may also be provided, although not shown in the analytics menu 500 of FIG. 9. Such other analytics options include, for example, a breakdown by investor, which may provide the demand breakdown by investor group and/or syndicate member for a particular price.

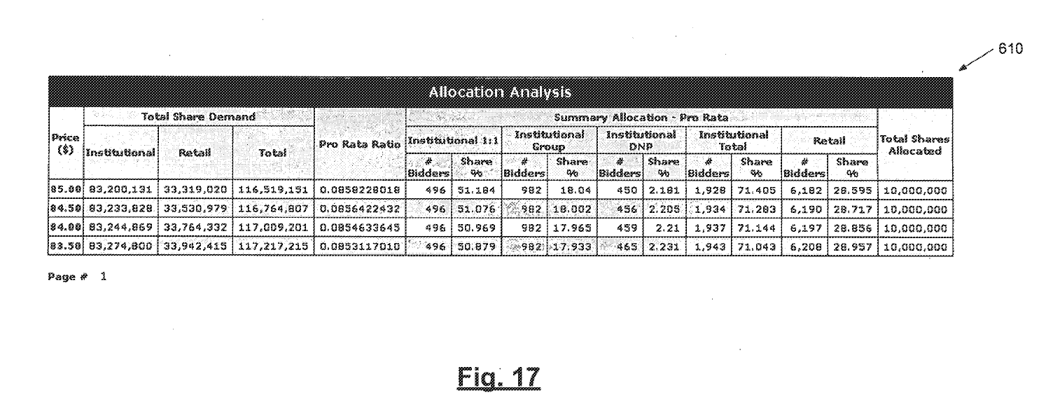

The analytics menu 500 may also include, for example, a hyperlink 515 for allowing the user to view the allocation analysis based on price, as shown in the sample output chart 610 of FIG. 17, and a hyperlink 516 that allows the user to set the criteria for the M&D bids.

In other applications, instead of being used for security offerings, the auction management system 10 described above could be used for security buy-backs. A buy-back is where an issuer of securities buys back outstanding shares so as to reduce the number of shares of the security outstanding. In such an application, the auction management system 10 may analyze offering bids from holders of the security to be bought back. The auction management system 10, in such an application, may be located at a site of the issuer (i.e., the entity buying back the securities).

According to yet other embodiments, bidders, either instead of or in addition to submitting bids through syndicate members, may submit bids directly to the auction management system 10, such as via a web-based system. For example, a prospective bidder could log onto a designated web site and submit a bid, as is known in conventional on-line auction sites. The auction management system 10 may compile and analyze the bids as described above. Such a web-based bidding system may also be used in buy-back applications.

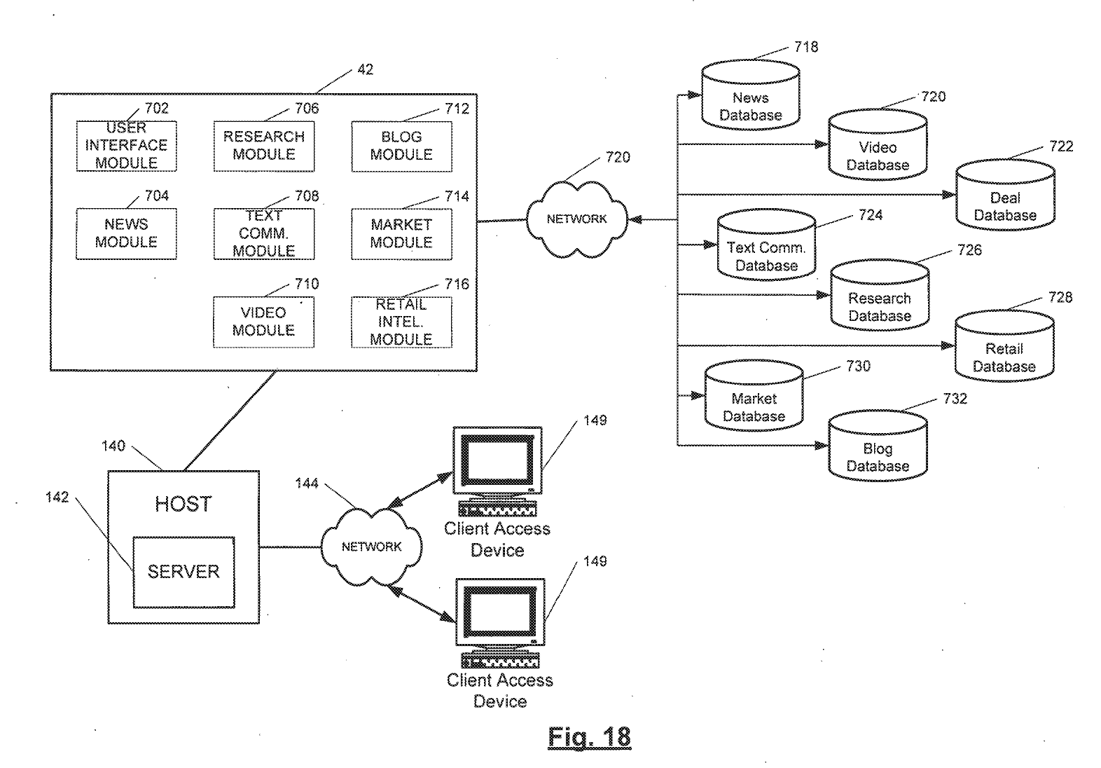

FIG. 18 is a diagram of the analytics system 42 configured to provide additional aggregated data to users before, during and after an offering. The system 42 may comprise a user interface module 702, which may be configured to receive and analyze incoming data as well as to present the data to users. Various other modules/functionalities may also be included to compile and present the aggregated data to the users. For example, a news module 704, a research module 706, a text communication module 708, a video module 710, a blog module 712, a market module 714 and a retail intelligence module 716 may be included. These modules/functionalities are described in more detail below. In addition to those modules shown, the analytics system 42 may also comprise other modules for the monitoring and/or management of offerings. For example, modules for M&D Bid Detection 136, Max Share Calculation 138, Allocation 134, Maximum Exposure 137, Price Demand 130, Investor Computation 132 and Share Size Demand 139 may be included, for example, as described above. Various other modules/functionalities may also be included in the analytics system 42 including, for example, other modules/functionalities for facilitating auctions. In addition to use with securities auctions, the analytics system 42 and the user interfaces that it generates may also be used in conjunction with traditional initial public offerings (IPO's) or other offerings based on the book-building method. These embodiments may include still other functionalities for facilitating the specific offering type.

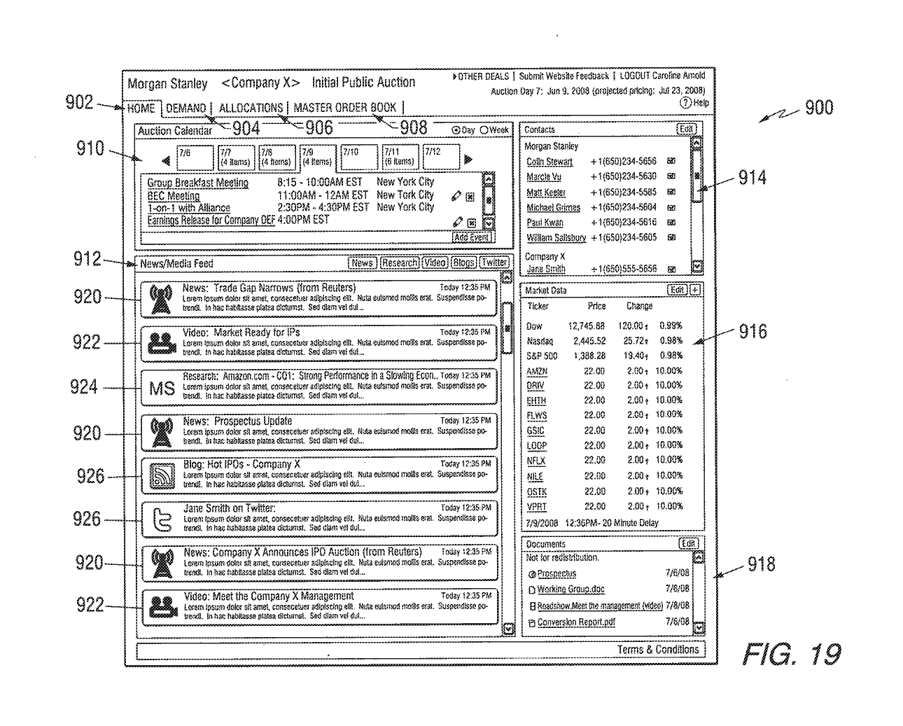

FIG. 19 depicts a user interface 900 generated by the user interface module 702 to provide aggregated data to various users. Intended users of the interface 900 may include representatives of the issuer (e.g., officers, issuer employees with responsibility for the offer, etc.). Other intended users of the interface 900 may include representatives of the underwriter or underwriters and/or any of the syndicate members 12. Potential investors or bidders may not be intended users of the interface 900. The interface 900 may comprise various screens and screen fields dedicated to providing information for various stages of the offering. Users may navigate between the various screens utilizing tabs 902, 904, 906, 908. In FIG. 19, the Home tab 902 is selected, showing a Home screen with various fields providing information relevant to the offering.

A News/Media field 912 comprises news/media items that may provide the user with background information regarding the issuer, companies similar to the issuer, as well as the relevant market and/or market segment. For example, the News/Media field 912 may comprise commingled items including, for example, News items 920, Video items 922, Research items 924, Blog items 926, and text communications items 928. Each of the items 920, 922, 924, 926, 928 may comprise a link that, when activated by the user, may open a separate screen (not shown) providing additional details of the item. For example, News items 920 listed in the News/Media field 912 may list a headline. Selecting the associated link may display a complete article.

Each item type 920, 922, 924, 926, 928 may be generated and then aggregated and sorted by the user interface module 702. For example, a news module 704 of the analytics system 42 may be in electronic communication with a news database 718 via a network 720. The news database 718 may be a proprietary database maintained by the underwriter. According to various embodiments, the news database 718 may comprise news items received from one or more news feed services such as, for example, BLOOMBERG, REUTERS, the ASSOCIATED PRESS, etc. In some embodiments, the news module 704 may actively scour the Internet for news items from publicly available sources. The network 720 may be any suitable local area network (LAN) or wide area network (WAN) and may, for example, comprise the Internet. The news module 704 may receive news data from the database 718 and apply a filtering algorithm to identify the news items that are most relevant to the offering. The identified News items 920 may provided to the user interface module 702 for inclusion in the News/Media field 912.

A research module 706 may be in electronic communication with a research database 726. The research database 726 may comprise research regarding the issuer as well as other companies that may or may not be related to the issuer. According to various embodiments, the research database 726 may comprise proprietary research reports and other research products generated by a securities research department of the underwriter and/or any of the syndicate members 112. Also, in some embodiments, the research database 726 may comprise independently generated reports and products received from outside research providers. The research module 706 may analyze the reports and other products contained in the research database 726 and identify the Research items 924 that are relevant to the offering. These may be provided to the user interface module 702 for inclusion in the News/Media field 912.

A video module 710 may be in electronic communication with a video database 720. The video module 710 may scour the video database 720 to identify videos relevant to the offering. For example, the video database may comprise videos from publicly available sources or from proprietary feeds. According to various embodiments, the video module, in addition to identifying relevant videos, may identify relevant portions of videos and queue or cut the video so that the relevant portions are viewed first. For example, an analyst may make an appearance on the BLOOMBERG TV and speak about several topics. Only one or two of the topics may be relevant to the offering. The video module 710 may review and clip the video to show only the relevant portions. According to various embodiments, the video module 710 may utilize a commercial service, such as SHADOW TV or YOUTUBE, to perform one or more of these functions. The generated Video items 922 may be provided to the user interface module 702 for inclusion in the News/Media field 912.

A blog module 712 may be in electronic communication with a blog database 732. The blog database 732 may comprise various blog entries that may be related to the offering. According to various embodiments, the blog module 712 may scour the Internet or other sources to populate the blog database 732 and identify Blog items 926 that may potentially be relevant to the offering. The generated Blog items 926 may be provided to the user interface module 702 for inclusion in the News/Media field 912.

A text communication module 708 may be in electronic communication with a text communication database 724. The text communication database 724 may comprise various text messages that may be relevant to the offering. For example, the text messages may be received from a publication/subscription (pub/sub) text service such as, for example, TWITTER. The text communication module 708 may subscribe to and monitor text streams from individuals or organizations that may be expected to comment on the offering. When a text item 928 relevant to the offering is detected, it may be provided to the user interface module 702 for inclusion in the News/Media field 912.

Accordingly, the user interface module 702 may receive various News items 920, Video items 922, Research items 924, Blog items 926 and text communication items 928 for inclusion in the News/Media field 912. The module 702 may determine the order of the various items in the field 912 according to any suitable method. In various embodiments, the items may be listed in the News/Media field 912 based on chronology, relevance and/or item type. For example, items may be listed chronologically with the most recent on top. In some embodiments, the various modules 704, 706, 708, 710 and 712 may provide their respective items with a numerical indication of their relevance to the offering. The user interface module 702 may then position the items in the News/Media field 912 with the most relevant items on top. Also, according to various embodiments, item type may be considered in determining the spatial position of the items. For example, News items 920 may be weighted higher than Blog items 926, causing News items 920 to appear higher in the News/Media field 912.

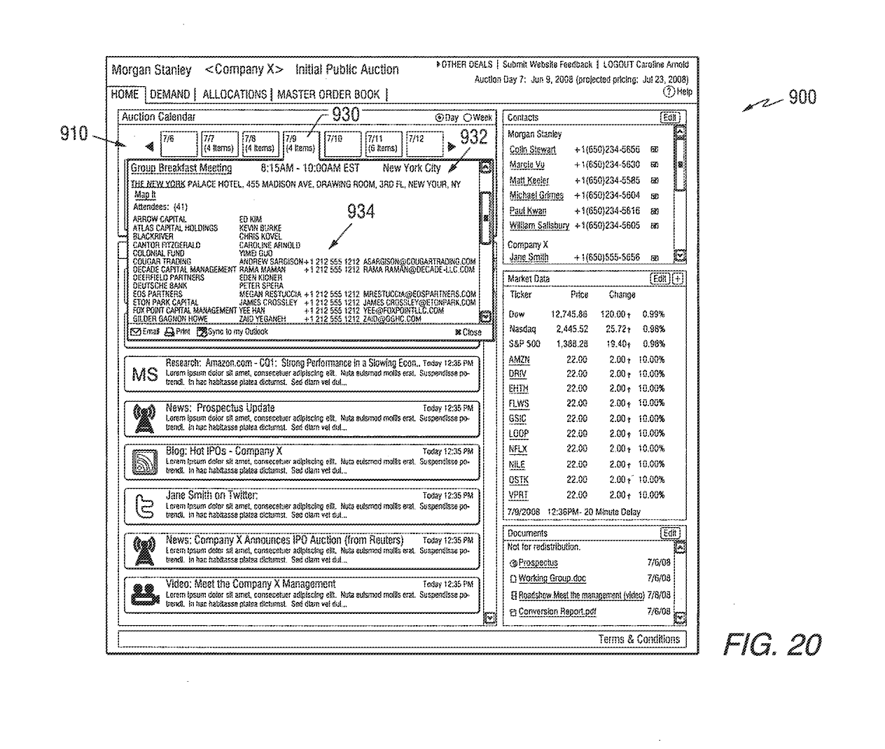

An Auction Calendar field 910 may provide information about events relating to the offering. Although the field 910 is referred to as an Auction Calendar field, it will be appreciated that it may be used in some offerings that are not auctions. The events described in the Auction Calendar field 910 may include, for example, different road shows and other meetings with potential investors. Calendar events may be managed and prepared by a calendar module 705 in communication with a deal database 722. The deal database 722 may comprise various data describing the deal including information describing the road shows and other events relevant to the deal. FIG. 20 depicts one embodiment of the user interface 900 configured to show details of a calendar item field selected from the Auction Calendar field 910. The calendar item field 930 provides information regarding a group breakfast meeting. Attendees at the meeting and their contact information may be provided at field 934. The calendar item field 930 may also include other links regarding the meeting including, a button 936 allowing a user to sync the Auction Calendar field 910 to their personal calendar and a map button, which may launch a map providing directions to the event.

Referring back to FIG. 19, a Contacts field 902 may list individuals involved in the deal as well as their contact information. This may allow users to quickly identify an appropriate person to contact as situations relating to the deal arise. For example, the Contacts field 914 may list representatives of the underwriter who are handling the offering. In this way, the Contacts field 914 may serve as a resource to the issuer, allowing the issuer to quickly identify and contact the appropriate personnel of the underwriter should any difficulties arise. According to various embodiments, the contact information may be stored at the deal database 722 and retrieved by the user interface module 702. A Documents field 918 may list documents and other data units relating to the offering. For example, the Documents field 918 may comprise links to a prospectus for the deal, a video road show provided by the management of the issuer, etc. According to various embodiments, documents listed at the Documents field 918 may be stored at the deal database 722 and retrieved by the user interface module 702.

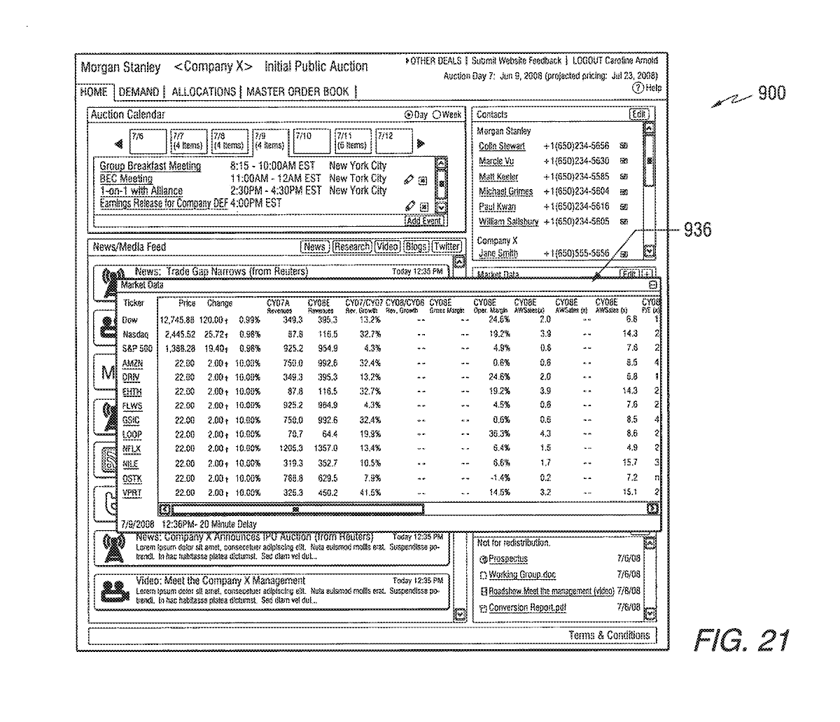

A Market Data field 916 may list data describing market conditions. Market data may be stored at a market database 730 which may be populated, for example, from publicly available sources or, for example, by one or more proprietary fees. The Market Data field 916 may list the current status of one or more publicly available indices describing the performance of the market as a whole as well as the current status of related companies. The selected companies may be determined, for example, based on their relation to the issuer. According to various embodiments, the related companies may include competitors of the issuer. In the example shown in FIG. 19, the issuer is an e-commerce company. Accordingly, the related companies include other e-commerce companies such as AMAZON (AMZN), DIGITAL RIVER (DRIV), EHEALTH, INC. (EHTH), and others. In embodiments where the issuer is already a public company (e.g., a debt offering, a buyback, etc.), the issuer may be one of the related companies. The related companies may be selected by the market module 714. For example, when the offering is an IPO or an IPO auction, the related companies may be public companies that are similar to the issuer. Similarity may be determined based on one or many company attributes including, for example, line of business (described above), earnings, profits, market capitalization (based on the expected market capitalization of the issuer), etc. FIG. 21 depicts one embodiment of the user interface of FIG. 19 configured to show a Market Data breakout field 936. The Market Data breakout field 936 may be displayed when a user selects the Market Data field 916. The breakout field 936 may display additional data about the indices and related companies including, for example, revenues, revenue growth, operating margins, sales and any other relevant and available data.

According to various embodiments, the market module 714 may work in conjunction with the user interface module 702, the news module 704, the research module 706, the text communication module 708, the video module 710 and the blog module 712 to generate the News/Media window 912. For example, various items of news, research, text communication, video and blogs may be considered more relevant, and therefore more likely to appear and appear prominently in the window 912, if it relates to one of the related companies identified by the market module 714. According to various embodiments, various data feeds, including, for example, the blog database 732, the news database 718, the video database 720, the text communication database 724 and the research database 726 may be limited to include only information relevant to the related companies.

According to various embodiments, the market module 714 may also calculate and display an index of market. The index of market may be an index, similar to the DOW JONES INDUSTRIAL AVERAGE, the S&P 500 and the NASDAQ indices. The components of the index of market (i.e., the securities prices that are aggregated), however, may be all or a portion of the related companies. In this way, the index of market may provide users with an indication of the general market performance of companies related to the issuer. It will be appreciated that the index of market may be aggregated from the security values (e.g. stock prices) of the related companies in any suitable way.

In some embodiments, various other information may be calculated and provided by the user interface module 702. For example, an index of progress may be provided. The index of progress may be a numerical indication of the degree of success of the various road shows and one-to-one meetings that have already been conducted. For example, records may be kept of the attendees at the various road shows, for example, at the deal database 722. The index of progress may be based on the bids received from these attendees. For example, it may be based on a number of attendees who submit at least one bid/request, a percentage of attendees who submit at least one bid/request. A number of bids/requests by bid or share number submitted by attendees, a percentage of the total demand or the demand from a given investor segment attributed to attendees, etc.

Also, for example, the user interface module 702 may be in electronic communication with a retail database 728. The retail database 728 may include information about the retail accounts held by the underwriter and/or one or more of the syndicate members 12, e.g., at a retail intelligence field (not shown). For example, the underwriter and/or one or more of the syndicate members 12 may own a retail brokerage. The records of the investing habits of investor accounts with the retail brokerage may be stored at the retail database 728 and used to provide useful information to the issuer. For example, prior to the offering, the retail database 728 may be analyzed to determine key information about the related companies including, for example, the percentage of their IPO buyers who continued to hold their securities after the passage of various time intervals. Also, for example, the geographic location of the primary holders of offered securities of the related companies may be determined. Pre-issue, this information may be useful to the issuer and the underwriter in various ways. For example, the issuer and underwriter may determine where to conduct pre-issue road shows or one-to-one meetings based on the geographic concentration of investors in the related companies and/or the geographic locations where the underwriter or syndicate members retail brokerages have the greatest penetration. Also, for example, allocations by geographic area may be appropriate to insure that geographic areas with high concentrations of investors in the related companies are reserved a portion of the offering.

After the offering, the interface 900 may remain available to the issuer and its representatives. For example, when the issuer is not public prior to the offering, it may be added, after the offering to the list of related companies considered by the market module 714 for Market window 916 and by the user interface module 702 and other related modules for the News/Media window 912. The retail data from database 728 may be utilized to determine, for example, the times that the winning bidders or purchasers at the offering hold the securities. In this way, the underwriter may maintain contact with the issuer, for example, to cross-sell additional services.

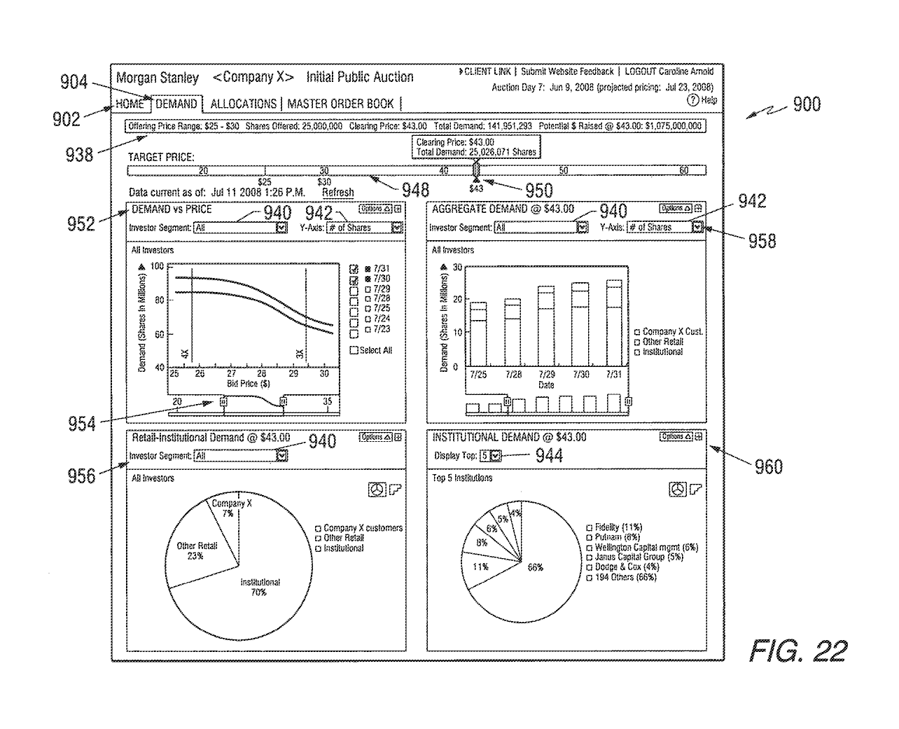

FIG. 22 depicts one embodiment of the user interface 900 displaying a Demand screen, indicated by the Demand tab 904. The Demand screen may provide information relating to the pre-offering demand for the issue. For example, when the offering is in the form of an auction, the pre-offering demand may represent the received bids. When the offering is in the form of a book-building IPO or other offering, the demand may represent book orders received by the underwriter or other orders. The Demand screen and its various windows and charts, may be generated by the user interface module 702 or any other suitable component or module of the analytics system 42. Demand data may be pulled from the various sources including, for example, the deal database 722 and/or the aggregations database 124 (FIG. 5).

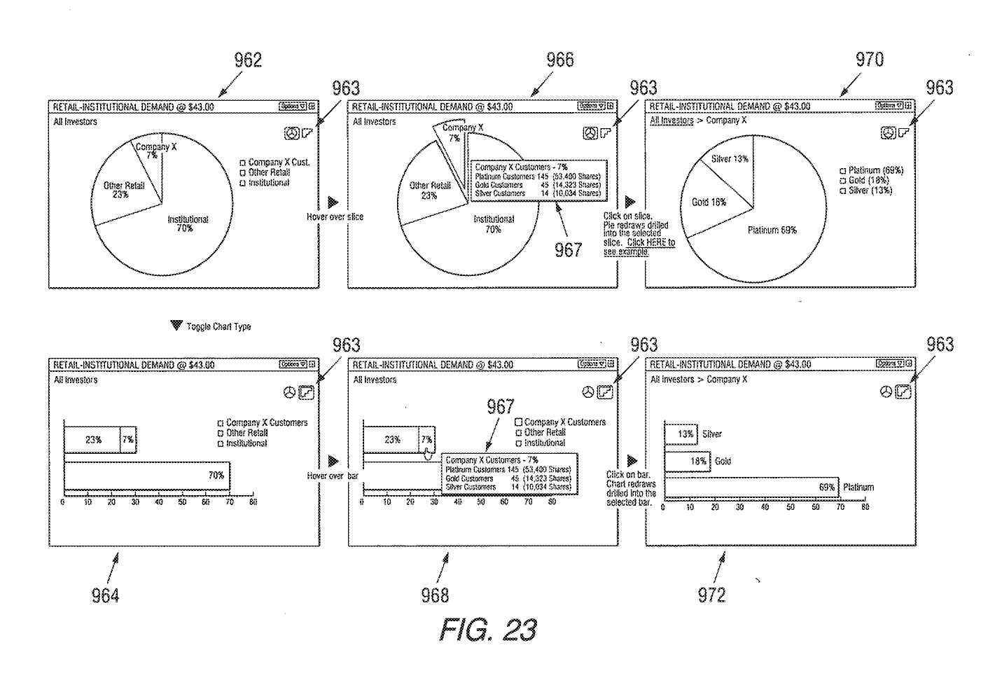

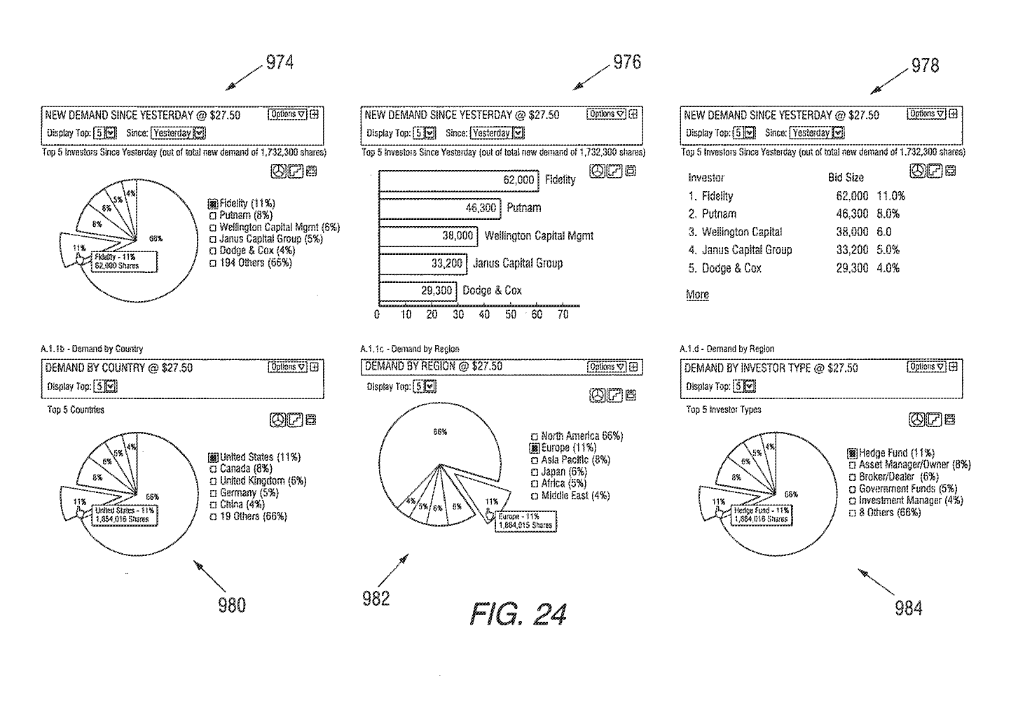

The Demand screen shown in FIG. 22 may comprise one or more windows 952, 956, 958, 960. Each of the windows may be configured to graphically and/or textually represent demand data. The Demand screen is shown in FIG. 22 with four windows 952, 956, 958, 960. FIGS. 23 and 24 illustrate additional windows that may be included in the Demand screen in addition to, or instead of the windows 952, 956, 960. A slider bar 948 and slider 950 on the Demand screen may allow the user to pick a clearing price that is then used as the basis of the graphical data presented in the various windows. A summary bar 938 may show an offering price range, a number of shares offered, the current clearing price set by the slider 950, the total demand at the selected clearing price, and the potential amount raised considering the demand, the clearing price and the number of shares offered.

Referring now to the windows 952, 956, 958, 960 shown in FIG. 22, window 952 illustrates a curve showing total demand versus price. Various other windows 956, 958, 960 may illustrate aggregate and relative demand across various categories. For example, demand data may be presented by individual investor or investor category (e.g., in a multi-tranche offering, by investor segment). Also, demand data may be presented, for example, by time (when bids are received), geographic location, (where bidders are located), etc.

The window 952 is configured to show total demand versus bid price. Demand, shown in the Y-axis, may be expressed as a number of shares or, for example, as a number of bids. An investor segment drop-down menu 940 may provide the user with functionality to select whether demand will be displayed in bids or shares. Also, the user may have the option, at demand form drop-down menu 942, of showing the demand across all investor types or may limit the curve to a specific investor type (e.g., in a multi-tranche offering, the user may wish to view the demand for a specific investor segment). The window 952 may comprise a neck 954. The neck 954 may allow the user to select a range on the X-axis that will be displayed by the window 952. The neck 954 may be slidable and also expandable/contractible, allowing the user to interactively change the X-axis range displayed above. It will be appreciated that because price is one of the variables illustrated in the window 952, the shape of the curve may not change as the clearing price is modified at the slider 950.

Window 958 is shown to display a graphical representation of aggregate demand at the clearing price set at the slider 950. As shown, the graphical representation is a bar chart by date. The bar chart, as illustrated, shows aggregate demand over all investor segments. Each bar may be broken down by investor segment, as shown. The user may limit the bar chart to show the aggregate demand from specific investor segments using investor segment drop-down menu 940. Again, aggregate demand may be expressed as a number of bids or a number of shares, selectable at demand form drop down menu 942. The window 958 may also comprise a neck 954 allowing the user to view the aggregate demand over different date ranges. Because the aggregate demand data illustrated in window 958 is presented at the clearing price set at the slider 950, the bar chart may change when the slider 950 is moved to a different clearing price to reflect aggregate demand at the new clearing price.

Window 956 illustrates a pie chart showing a break down of demand between investor segments. For example, as shown in FIG. 22, the window 956 shows a break down between an institutional investor segment, an affinity investor segment (labeled as Company X) and an investor segment labeled “Other Retail.” The pie chart shown in window 956 illustrates a demand break down across all investors. The user, however, may limit investor segments shown by utilizing an investor segment drop down menu 940. For example, window 960 illustrates a pie chart showing a demand break down between institutional investors. The demand percentage of the top five institutional investors are illustrated in the pie chart, with all others represented as a single slice. A display drop down menu 944 may allow the user to select the number of institutional investors whose demand is specifically shown. As described, the data shown in windows 956 and 960 may change dynamically based on the clearing price set using the slider 950.

According to various embodiments, users may be able to select the specific data that is shown in each of the windows 952 and may also be able to drill down to higher levels of detail. For example, FIG. 23 depicts one embodiment of a series of windows from the Demand screen shown in FIG. 22. Window 962 shows a pie chart illustrating the break down of demand between different investor segments, similar to that shown in the window 956. From this window 962, the user may toggle the chart type at buttons 963 from a pie chart to a bar chart. The result is shown at window 964. Alternatively, from window 962, the user may select one of the slices, causing the interface 900 to display more detailed information about the selected slice, including, for example, demand numbers from nested categories of investor segments shown by field 967 in window 966. Selecting the slice a second time may cause a new pie chart to be displayed illustrating a break down of demand within the selected investor segment. An example is shown in window 963.

Starting from window 964, it will be appreciated that similar operations may be performed, for example, by selecting a portion of the bar chart shown in 964 to display information about the investor segment represented by the selected portion (e.g., field 967 of window 968). Selecting the segment again may cause a new bar chart to be shown focused on the selected investor segment, for example, as shown in window 972. Also, it will be appreciated that the user may toggle between different chart types in any of the windows 962, 964, 966, 968, 970, 972 utilizing the toggle buttons 963.

FIG. 24 depicts one embodiment of a second series of windows from the Demand screen of FIG. 22. Window 974 illustrates demand by time, with the illustrated pie chart showing a relative breakdown of the demand received over a previous day by individual investor. Window 976 illustrates the data from window 972 in a bar chart format, while window 978 illustrates the same data as a table. Window 984 shows a pie chart illustrating relative demand by investor type. Windows 980 and 982 show pie charts illustrating demand by geographic locations, with window 980 organized by country and window 982 organized by region.

In practice, any of the windows 962, 964, 966, 968, 970, 972, 974, 976, 978, 980, 982, 984 may be displayed as a part of the Demand screen of the interface 900 illustrated in FIG. 22. Also, as described above, the graphical representations of the demand data may be updated in real time based on the clearing price, as set by the user utilizing the slider 950.

The demand data presented by the Demand screen of the interface 900 may be utilized by the users in various ways. For example, when the offering is an auction, the Demand screen may allow the user (e.g., the underwriter and/or representatives of the issuer) to determine the total demand and the mix of investor types at different clearing prices. This may allow the underwriter and issuers to select a demand price that best balances price while maintaining a desirable investor mix. Underwriters in book-running IPO's may utilize the data presented in the Demand screen in a similar fashion, for example, to determine an ultimate clearing price.

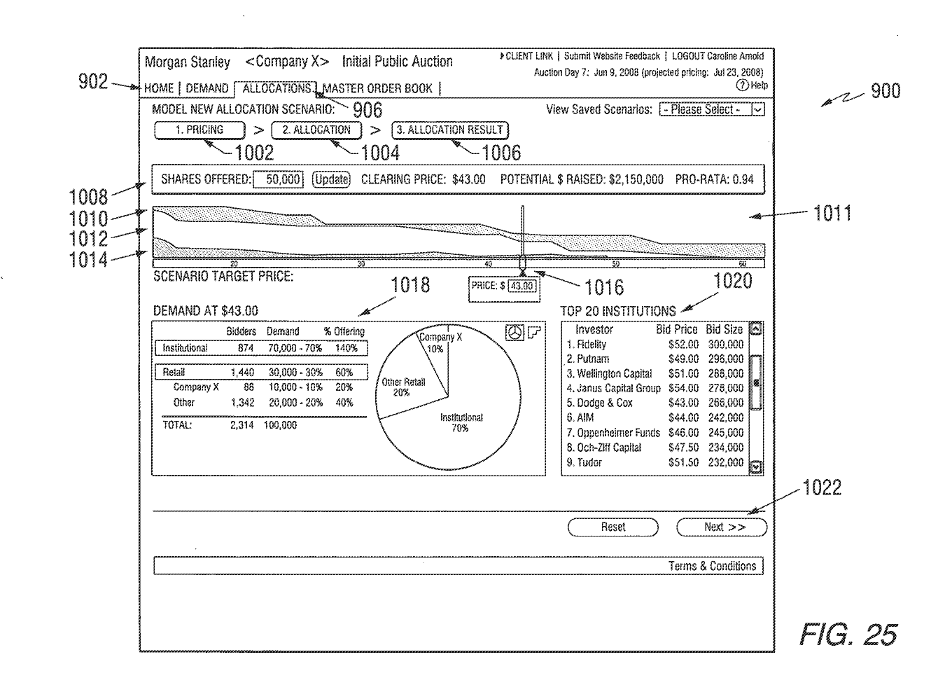

FIG. 25 depicts one embodiment of the user interface 900 displaying an Allocations screen. The user may cause the Allocations screen of FIG. 25 to be displayed, for example, by selecting the Allocations tab 906. The Allocations screen may be displayed to a user to allow the user to manually close an offering (e.g., an auction). Accordingly, in various embodiments, access to the Allocations screen may be more limited than that to the Demand and Home screens described above. For example, the Allocations screen may only be accessible by users with the authority to set the clearing price and determine allocation methods. Data displayed on the Allocations screen may be received from the deal database 722 and/or the aggregations database 124 (FIG. 5). Commands received the user via the Allocations screen may be provided to the auction management system 10 or other control system (e.g., in embodiments that do not involve an auction).

The Allocation screen may guide a user through a three stage allocation process. The first stage, pricing 1002, is illustrated in FIG. 25. The pricing stage may cause the Allocations screen to display an area chart 1011 of demand versus clearing price. The area chart 1011 may also show a breakdown of demand by investor. For example, as illustrated, a first band 1014 may indicate an affinity based investor segment or segments, a second band 1012 may indicate an institutional investor segment and a third band 1010 may indicate an investor segment of other retail investors. According to various embodiments, more or fewer investor segments may be shown. A summary bar 1008 may provide other relevant data including, for example, a number of shares offered, a clearing price, a pro-rata fraction based on the current demand and price as well as a potential money raised by the offering considering the demand and the clearing price. Various other demand data windows 1018, 1020 similar to the demand windows described in conjunction with the Demand screen may provide further information for the user as the clearing price is set. A slider 1016 may be positioned under the chart 1011 to allow the user to set the clearing price. When the user is satisfied with the selected clearing price, the Next button 1022 may be selected to advance to the allocation stage.

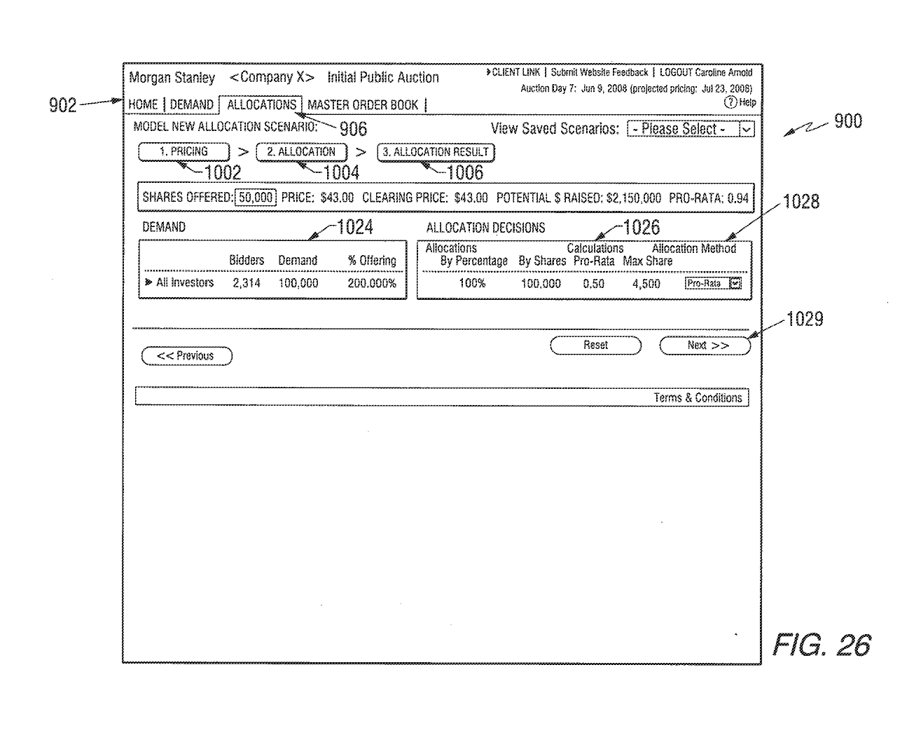

FIG. 26 depicts one embodiment of the Allocations screen of FIG. 25 illustrating an allocation stage. The summary bar 1008 may list the shares offered, price, clearing price, potential money raised and pro-rata fraction based on the clearing price selected at the pricing stage. A Demand window 1024 may list the demand based on the selected clearing price. The demand may be indicated by the number of bidders, a number of shares and/or by a percent of the total offering. An Allocation Decisions window 1026 may allow the user to enter instructions regarding how the available shares are to be allocated among the successful bidders (e.g., the demand based on the selected clearing price). In addition, the Allocation Decisions window 1026 may provide information about various allocation methods including, for example, a pro-rata percentage based on the total demand and a max share amount based on the total demand. As shown in FIG. 26, the Demand and Allocation Decisions windows 1024, 1026 are illustrated to shown one segment of investors, “All Investors.” In offerings that are not tranched, this may be the smallest unit of investors. Accordingly, the user may select an allocation method (e.g., pro rata, max shares, lottery, etc.) for “All Investors” as drop-down menu 1028 and enter it to the system 10 by selecting the Next button 1029.

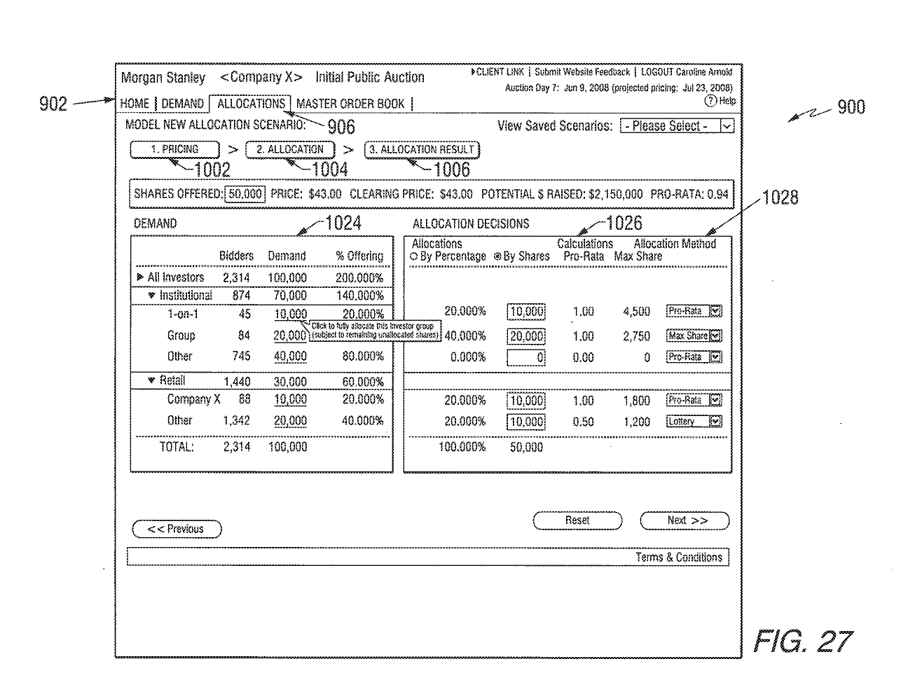

FIG. 27 depicts one embodiment of the Allocations screen as shown in FIG. 25 with the Demand and Allocation Decisions windows expanded to show selected investor segments, for example, in an offering having multiple tranches. The Demand window 1024 may show the number of bidders and the total demand from each investor segment and sub-segment. The Allocation Decisions window 1026 may include additional input fields allowing the user to specify and/or modify the portion of the total offering assigned to each tranche/investor segment. The Allocation Method field may allow the user to select an allocation method for each of the investor segments/tranches. If an over or under-allotment condition exists between tranches, this may be handled, for example, as described above with respect to FIGS. 4A and 4B.

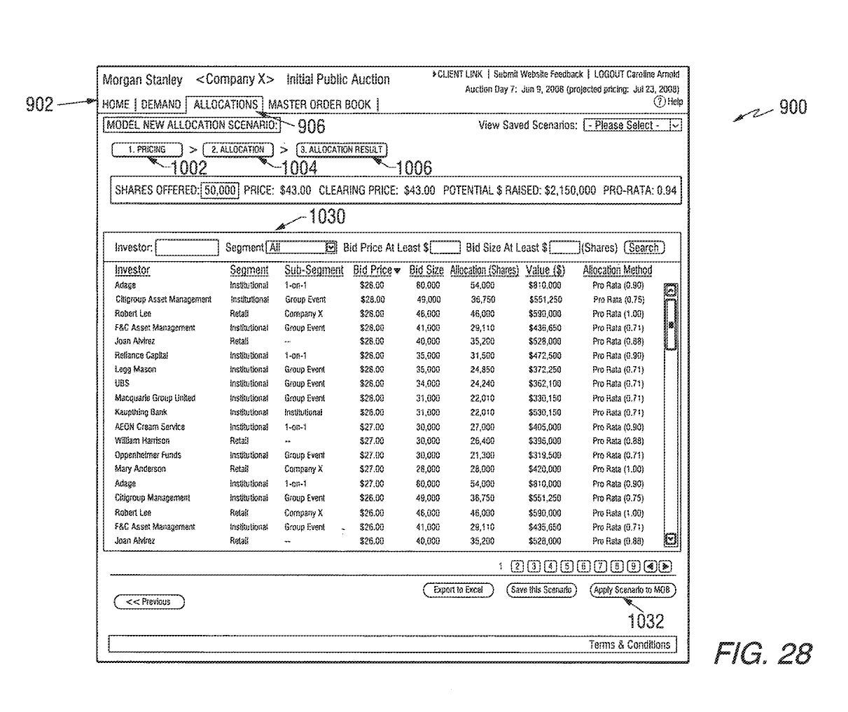

FIG. 28 depicts one embodiment of the Allocations screen as shown in FIG. 25 displaying an allocation result stage. A table 1030 may list allocation information based on the clearing price, tranche allocation, and allocation methods selected, for example, as described above. For each investor, the table 1030 may list an investor segment to which the investor belongs, a sub-segment, if any, a bid price, a bid size, a number of shares, a share value, and the allocation method used in the investors' segment/sub-segment. Provided that the user is satisfied with the results, the user may finalize the allocations by selecting the Apply Scenario To MOB button 1032 in order to apply the decisions from the Pricing and Allocation stags to the master order book.

In general, it will be apparent to one of ordinary skill in the art that at least some of the embodiments described herein may be implemented in many different embodiments of software, firmware, and/or hardware. The software and firmware code may be executed by a processor or any other similar computing device. The software code or specialized control hardware that may be used to implement embodiments is not limiting. For example, embodiments described herein may be implemented in computer software using any suitable computer software language type, using, for example, conventional or object-oriented techniques. Such software may be stored on any type of suitable computer-readable medium or media, such as, for example, a magnetic or optical storage medium. The operation and behavior of the embodiments may be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes associated with the present embodiments may be executed by programmable equipment, such as computers or computer systems and/or processors. Software that may cause programmable equipment to execute processes may be stored in any storage device, such as, for example, a computer system (nonvolatile) memory, an optical disk, magnetic tape, or magnetic disk. Furthermore, at least some of the processes may be programmed when the computer system is manufactured or stored on various types of computer-readable media.

It can also be appreciated that certain process aspects described herein may be performed using instructions stored on a computer-readable medium or media that direct a computer system to perform the process steps. A computer-readable medium may include, for example, memory devices such as diskettes, compact discs (CDs), digital versatile discs (DVDs), optical disk drives, or hard disk drives. A computer-readable medium may also include memory storage that is physical, virtual, permanent, temporary, semipermanent, and/or semitemporary.

A “computer,” “computer system,” “host,” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-implemented devices disclosed herein may include memory for storing certain software applications used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable media.

In various embodiments disclosed herein, a single component may be replaced by multiple components and multiple components may be replaced by a single component to perform a given function or functions. Except where such substitution would not be operative, such substitution is within the intended scope of the embodiments. Any servers described herein, for example, may be replaced by a “server farm” or other grouping of networked servers (such as server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand and/or providing backup contingency in the event of component failure or reduction in operability.

While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

1-49. (canceled)

50. A system for allocating units of a security to potential investors in an auction of the security, the system comprising:
a computer device, the computer device comprising an electronic processor in electronic communication with an associated memory circuit, wherein the memory circuit comprises instructions that, when executed by the at least one processor, causes the computer device to:
receive from an electronic database a plurality of bids of potential investors in the auction, wherein each of the plurality of bids comprises (i) a quantity amount indicating a quantity of the units of the security, (ii) a price amount indicating a price per unit of the security, and (iii) an indicator of a bidding investor placing the bid;
divide the plurality of bids into a plurality of investor segments, wherein each of the plurality of investor segments comprises potential investors having common characteristics, and wherein the plurality of investor segments comprises: (i) a first customer investor segment consisting of potential investors that are non-security related customers of the issuer at above a predetermined level, (ii) a second customer investor segment comprising potential investors that are non-security related customers of the issuer below the predetermined level, and (iii) a third investor segment;
determine winning bidders from the potential investors based on the plurality of bids;
allocate to winning bidders of the first customer investor segment the units of the security from a first tranche corresponding to the first customer investor segment according to a first allocation method, wherein the first tranche comprises a portion of the units of the security;
allocate winning bidders of the second customer investor segment units of the security from a second tranche corresponding to the second customer investor segment, wherein the second tranche comprises shares of the first tranche that remain after the first tranche is allocated to the first customer investor segment; and
allocate winning bidders of the third investor segment units of the security from a third tranche corresponding to the third investor segment according to a second allocation method different than the first allocation method.

51. The system of claim 50, wherein the first allocation and the second allocation methods are selected from the group consisting of pro rata allocation, max shares allocation and lottery allocation.

52. The system of claim 50, wherein the plurality of investor segments comprises an institutional investor segment comprising potential investors who are institutional investors.

53. The system of claim 50, wherein the plurality of investor segments comprises a first geographic investor segment comprising potential investors from a first geographic area.

54. The system of claim 53, wherein the first geographic area is an area of market penetration by a retail brokerage associated with at least one of an underwriter of the offering and a syndicate member of the offering.

55. The system of claim 53, wherein the first geographic area is selected considering a geographic distribution of customers of the issuer.

56. The system of claim 50, wherein the plurality of investor segments comprises a road show investor segment comprising potential investors who attended at least one of: a road show, and a one-to-one meeting promoting the offering.

57. The system of claim 50, wherein the plurality of investor segments comprises a customer referral segment comprising investors who have referred at least a predetermined amount of business to the issuer.

58. The system of claim 50, wherein the predetermined level indicates a level of profit generated by the potential investors for the issuer.

59. The system of claim 50, wherein the predetermined level indicates a frequency at which the potential investors patronize the issuer.

60. A computer-implemented method for allocating units of a security to potential investors in an auction of the security, the method comprising:
receiving, with a computer device and from an electronic database, a plurality of bids of potential investors in the auction, wherein the computer device comprises an electronic processor in electronic communication with an associated memory circuit, and wherein each of the plurality of bids comprises (i) a quantity amount indicating a quantity of the units of the security, (ii) a price amount indicating a price per unit of the security, and (iii) an indicator of a bidding investor placing the bid;
dividing, with the computer device, the plurality of bids into a plurality of investor segments, wherein each of the plurality of investor segments comprises potential investors having common characteristics, wherein the plurality of investor segments comprises at least (i) a first customer investor segment consisting of potential investors that are non-security related customers of the issuer at above a predetermined level, and (ii) a second customer investor segment comprising potential investors that are non-security related customers of the issuer below the predetermined level, and (iii) a third investor segment;
determining, with the computer device, winning bidders from the potential investors based on the plurality of bids;
with the computer device, allocating to winning bidders of the first customer investor segment, the units of the security from a first tranche corresponding to the first customer investor segment according to a first allocation method, wherein the first tranche comprises a portion of the units of the security;
with the computer device, allocating winning bidders of the second customer investor segment units of the security from a second tranche corresponding to the second customer investor segment, wherein the second tranche comprises shares of the first tranche that remain after the first tranche is allocated to the first customer investor segment; and
with the computer device, allocating winning bidders of the third investor segment units of the security from a third tranche corresponding to the third investor segment according to a second allocation method different than the first allocation method.

61. The method of claim 60, wherein the first allocation and the second allocation methods are selected from the group consisting of pro rata allocation, max shares allocation and lottery allocation.

62. The method of claim 60, wherein the plurality of investor segments comprises an institutional investor segment comprising potential investors who are institutional investors.

63. The method of claim 60, wherein the plurality of investor segments comprises a first geographic investor segment comprising potential investors from a first geographic area.

64. The method of claim 63, wherein the first geographic area is an area of market penetration by a retail brokerage associated with at least one of an underwriter of the offering and a syndicate member of the offering.

65. The method of claim 63, wherein the first geographic area is selected considering a geographic distribution of customers of the issuer.

66. The method of claim 60, wherein the plurality of investor segments comprises a road show investor segment comprising potential investors who attended at least one of: a road show, and a one-to-one meeting promoting the offering.

67. The method of claim 60, wherein the plurality of investor segments comprises a customer referral segment comprising investors who have referred at least a predetermined amount of business to the issuer.

68. The method of claim 60, wherein the predetermined level indicates a level of profit generated by the potential investors for the issuer.

69. The method of claim 60, wherein the predetermined level indicates a frequency at which the potential investors patronize the issuer.
